(19) United States
(12) Patent Application Publication
(10) Pub. No.: US 2026/0294042 A1
(43) Pub. Date: Oct. 1, 2026

(54) FOOTWEAR ARTICLE WITH COMPOSITE TEXTILE

(71) Applicant: NIKE, Inc., Beaverton, OR (US)

(72) Inventors: Holly E. Harris, Brevard, NC (US); Anand P. Kanchagar, Portland, OR (US); Christian A. Steinbeck, Portland, OR (US)

(21) Appl. No.: 19/578,511

(22) Filed: Mar. 25, 2026

Related U.S. Application Data
(60) Provisional application No. 63/778,204, filed on Mar. 26, 2025.
(60) Provisional application No. 63/870,109, filed on Aug. 25, 2025.

(51) Int. Cl. A43B 23/02; A43B 1/00; A43B 1/028; A43B 1/04; A43B 1/05; B32B 5/02; B32B 27/12

(52) U.S. Cl. CPC A43B 23/0235; A43B 1/0009; A43B 1/028; A43B 1/04; A43B 1/05; A43B 23/025; B32B 5/022; B32B 5/024; B32B 5/026; B32B 27/12; B32B 2255/02; B32B 2255/26; B32B 2262/0207; B32B 2307/404; B32B 2437/02

(57) ABSTRACT

This disclosure relates to a footwear article with a composite textile, which imparts a balance of various properties, such as softness, flexibility, stability, stretch and recovery, breathability, durability, and weight. In at least one example, the composite textile includes a nonwoven fiber web that is coupled to a mesh material layer. The nonwoven fiber web and the mesh material layer can function as a substrate or other type of base layer that can be coupled with one or more other layers. For example, the composite textile can include a polymer film that is coupled (e.g., via hotmelt) to the substrate and that functions as a protective outer layer of the footwear article.

### CROSS REFERENCE TO RELATED APPLICATIONS

This application claims the priority benefit of U.S. 63/778,204 (filed Mar. 26, 2025) and claims the priority benefit of U.S. 63/870,109 (filed Aug. 25, 2025). Each of the aforementioned applications is incorporated herein by reference in its entirety.

### BACKGROUND

Footwear articles typically include an upper that is coupled to a sole and that is configured to at least partially enclose a foot-receiving cavity. Footwear uppers include properties that can differ depending on various factors, such as the type of footwear article and its intended use. In addition, footwear uppers can be constructed of different materials, which can be selected to help impart desired properties.

### BRIEF DESCRIPTION OF DRAWINGS

The present systems and methods for a footwear article with composite textile are described in detail below with reference to these figures.

FIG. 1 depicts an example footwear article with a composite textile, in accordance with examples of this disclosure, and FIG. 1 includes reference lines associated with Reference View A-A.

FIG. 1A depicts Reference View A-A that is identified in FIG. 1.

FIG. 2 depicts a method of constructing a composite textile, as well as structures associated with the composite textile, in accordance with examples of this disclosure.

FIG. 3A depicts an example composite textile, in accordance with examples of this disclosure.

FIG. 3B depicts another example composite textile, in accordance with examples of this disclosure.

FIG. 3C depicts another example composite textile, in accordance with examples of this disclosure.

FIG. 4 depicts another example composite textile, in accordance with examples of this disclosure.

FIG. 5 depicts a graph showing material properties of different composite textiles, in accordance with examples of this disclosure.

### DETAILED DESCRIPTION

This detailed description is related to a footwear article with a composite textile, which imparts a balance of various properties, such as softness, flexibility, stability, stretch and recovery, breathability, durability, and weight. In addition, the composite textile can serve as a platform textile (e.g., base textile) with properties that can be tuned or supplemented for use across various types of footwear articles with different purposes, designs, and functionality. In at least one example, the composite textile includes a nonwoven staple-fiber web that is coupled with a mesh material layer (e.g., knit mesh textile), such as by entanglement, adhesive, and/or other bonding mechanisms. The nonwoven staple-fiber web and the mesh material layer can function as a substrate or other type of base layer that can be coupled with one or more other layers. For example, the composite textile can include a polymer film that is coupled (e.g., via hotmelt, direct deposit, etc.) to the substrate and that functions as a protective outer layer of the footwear article. In examples, the properties of the individual layers, as well as the way they are coupled, can be selected to impart desired properties to the composite textile. In addition, one or more additional elements or layers can be included on the film to configure the surface properties and characteristics, such as a topcoat, surface protuberances or raised structures, and the like.

Conventional composite textiles might combine a nonwoven layer (e.g., fibers of a nonwoven layer) with another textile, but these conventional composite textiles often include fibers (at least portions of fibers) on the surface of the composite textile to mimic some types of natural leather (e.g., suede or nubuck). For example, the portions of the fibers on the surface can form piles, which can be buffed to impart leather-like appearances. In contrast to these conventional composite textiles, at least some examples of the present disclosure include a polymer film coupled to and covering the substrate with the nonwoven staple-fiber web, such that minimal, little, or no fiber portions extend through to the outer face.

In addition, some conventional composite textiles, which include a nonwoven layer coupled with another textile, include microfibers (e.g., multi-component fibers that can be processed into smaller fibers via mechanical splitting, chemical treatment, etc.) in the nonwoven layer, and microfibers can be associated with various drawbacks and disadvantages. For example, microfibers can be expensive and can require intensive labor, chemical treatment, and/or less sustainable techniques for effective incorporation into the composite textile. In addition, microfibers can sometimes require higher amounts or volume (e.g., higher basis weight) to achieve desired end properties in the composite textile, such as composite textile thickness. In contrast to these conventional composite textiles, at least some examples of a composite textile in this present disclosure include a nonwoven staple-fiber web that does not include microfibers and that still includes satisfactory, or even improved, properties. For instance, the nonwoven staple-fiber web can include, in some examples, fibers that are infused with silicone (e.g., the fibers are made of a solid dispersion of silicone in combination with some other polymer) and that can impart desired stiffness and other properties to the composite textile. Stated differently, the silicone-infused fibers can be associated with lower stiffness and can, in some cases, contribute to a lower composite textile stiffness, which can be similar to composites with microfibers but without the disadvantages of the microfibers. In some instances, using fibers having a larger diameter than microfibers can be easier to bond to, such as with a hotmelt, since the network of larger-diameter fibers (e.g., larger than microfibers) can be less dense with larger interstitial space.

Often, conventional solutions couple a nonwoven web (or some other form of fibers) with another textile layer by fluid entanglement (e.g., hydro entanglement, air entanglement, etc.). In contrast, some examples of the present disclosure couple the nonwoven staple-fiber web with a mesh textile using mechanisms other than hydroentanglement, such as needle punching or adhesive (e.g., hot-melt adhesive). Needle punching can, as compared to fluid entanglement, more effectively entangle a higher basis weight nonwoven web and maintain loft and softness of the composite textile, among other things. In addition, the needle punch parameters (e.g., stitch density, penetration depth, needle type, etc.) can be adjusted to impart desired properties to the composite textile.

Additional advantages and distinctive features of the present disclosure are described in more detail below.

“A,” “an,” “the,” “at least one,” and “one or more” might be used interchangeably to indicate that at least one of the items is present. When such terminology is used, a plurality of such items might be present unless the context clearly indicates otherwise.

All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. The term “about” can include +/−10% of a given element, if that numerical definition is necessary to understand the scope of a claimed element. In addition, a disclosure of a range is to be understood as specifically disclosing all values and further divided ranges within the range.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives might be employed throughout this detailed description corresponding to the illustrated examples. Ordinary skilled artisans will recognize that terms such as “above,” “below,” “upward,” “downward,” “top,” “bottom,” etc., may be used descriptively relative to the figures, without representing limitations on the scope of the invention, as defined by the claims.

The term “longitudinal,” as possibly used throughout this detailed description and in the claims, refers to a direction extending along the length of a component. For example, a longitudinal direction of a shoe extends between a forefoot region and a heel region of the shoe. The term “forward” or “anterior” is used to refer to the general direction from a heel region toward a forefoot region, and the term “rearward” or “posterior” is used to refer to the opposite direction, i.e., the direction from the forefoot region toward the heel region. In some cases, a component may be identified with a longitudinal axis, as well as a forward and rearward longitudinal direction along that axis. The longitudinal direction or axis may also be referred to as an anterior-posterior direction or axis.

The term “transverse,” as possibly used throughout this detailed description and in the claims, refers to a direction extending along the width of a component. For example, a transverse direction of a shoe extends between a lateral side and a medial side of the shoe. The transverse direction or axis may also be referred to as a lateral direction or axis or a medio-lateral direction or axis.

The term “vertical,” as possibly used throughout this detailed description and in the claims, refers to a direction generally perpendicular to both the lateral and longitudinal directions. For example, in cases where a sole is positioned flat on a ground surface, the vertical direction may extend from the ground surface upward. It will be understood that each of these directional adjectives may be applied to individual components of a sole. The term “upward” or “upwards” refers to the vertical direction pointing towards a top of the component, which may include an instep, a fastening region, and/or a throat of an upper. The term “downward” or “downwards” refers to the vertical direction pointing opposite the upwards direction, toward the bottom of a component, and may generally point towards the bottom of a sole structure of an article of footwear.

The “interior” of a footwear article refers to portions of the space that is occupied by a wearer's foot when the shoe is worn. The interior can also be referred to as the “foot-receiving cavity.” The “inner side” of a footwear component refers to the side or surface of the component that is (or will be) oriented toward the interior of the component or article of footwear in an assembled article of footwear. The “inner side” can also be referred to as the “inward-facing side” or “inward-facing surface.” In some examples, the inner-facing surface may mean the innermost-facing surface or the innermost surface or innermost face of the upper or article of footwear. The “outer side” or “exterior” of a component refers to the side or surface of the component that is (or will be) oriented away from the interior of the shoe in an assembled shoe. The “outer side” can also be referred to as the “outer-facing side” or “outer-facing surface,” as well as the “exterior-facing side” or “exterior-facing surface.” These terms can describe a surface of the upper or article of footwear that faces the external environment. In some examples, the outer-facing surface may mean the outermost-facing surface or outermost surface or outermost face of the upper or article of footwear. The terms “external” and “internal” as used herein are relative terms such that a layer that is external is positioned external to one or more internal layers, and a layer that is internal is positioned internal to one or more external layers.

In some cases, other components may be between the inner side of a component and the interior in the assembled article of footwear. Similarly, other components may be between an outer side of a component and the space external to the assembled article of footwear. Further, the terms “inward” and “inwardly” shall refer to the direction toward the interior of the component or article of footwear, such as a shoe, and the terms “outward” and “outwardly” shall refer to the direction toward the exterior of the component or article of footwear, such as a shoe.

In addition, the term “proximal” refers to a direction that is nearer a center of a footwear component, or is closer toward a foot when the foot is inserted in the article of footwear as it is worn by a user. Likewise, the term “distal” refers to a relative position that is further away from a center of the footwear component or is further from a foot when the foot is inserted in the article of footwear as it is worn by a user. Thus, the terms proximal and distal may be understood to provide generally opposing terms to describe relative spatial positions.

Examples of this disclosure can include fibers or filaments, which can be used to construct nonwovens, knits, weaves, braids, and the like. As used in this disclosure the term “nonwoven” means an engineered fibrous assembly, primarily planar, which has been given a designed level of structural integrity by physically and/or chemically coupling fibers, excluding weaving, knitting, braiding, or paper making. Non-limiting examples of nonwovens can include staple-fiber nonwovens (e.g., formed by carding, possibly lapping, and needle entanglement or fluid entanglement), spunbond nonwovens, spunlace nonwovens, meltblown nonwovens, airlaid nonwovens, wetlaid nonwovens, and melt-blown nonwovens.

In examples, the terms “filament,” “fiber,” or “fibers” refer to materials or structures that are in the form of discrete elongated pieces that are significantly longer than they are wide. A fiber can include natural, manmade or synthetic fibers. The fibers may be produced by conventional techniques, such as extrusion, electrospinning, interfacial polymerization, pulling, and the like.

Fibers can include carbon fibers, boron fibers, silicon carbide fibers, titania fibers, alumina fibers, quartz fibers, glass fibers, such as E, A, C, ECR, R, S, D, and NE glasses and quartz, or the like. The fibers can be fibers formed from synthetic polymers capable of forming fibers such as poly(ether ketone), polyimide, polybenzoxazole, poly(phenylene sulfide), polyesters (e.g., polyethylene terephthalate (PET)), polyolefins (e.g., polyethylene, polypropylene), aromatic polyamides (e.g., an aramid polymer such as para-aramid fibers and meta-aramid fibers), aromatic polyimides, polybenzimidazoles, polyetherimides, polytetrafluoroethylene, acrylic, modacrylic, poly(vinyl alcohol), polyamides, polyurethanes, and copolymers such as polyether-polyurea copolymers, polyester-polyurethanes, polyether block amide copolymers, or the like. The fibers can be natural fibers (e.g., silk, wool, cashmere, vicuna, cotton, flax, hemp, jute, sisal). The fibers can be man-made fibers from regenerated natural polymers, such as rayon, lyocell, acetate, triacetate, rubber, and poly(lactic acid). The fibers can, in some examples, include organic polymers. The fibers can, in some examples, include inorganic material fibers.

In at least some examples, a fiber can be formed by a dispersion (e.g., solid dispersion) of a first synthetic polymer (e.g., polyester or PET or polyamide) with a silicone polymer. For example, fibers can be formed by a solid dispersion of the first synthetic polymer and silicone. In at least some examples, the first synthetic polymer and the silicone can be mixed or blended prior to the resulting polymer matrix being extruded into the fiber form. In some examples, fibers can be “infused” with silicone (e.g., silicone-infused fibers), and as used herein “infused” describes that the silicone is included in the solid dispersion that forms the fiber. In some examples, the silicone can be homogenously mixed throughout the solid dispersion (e.g., the silicone mixed with one or more other synthetic polymers, such as polyester or polyamide). In addition, the silicone can be included in various amounts, and in some examples, the fiber comprises between 0.1 and 20 weight % silicone (and one or more other synthetic polymers). In at least some examples, the silicone is present at room temperature (25° C.) in the form of dispersed, compacted inclusions which as a result of thermoplastic processing, e.g. by blending in the melt extruder, are distributed substantially homogeneously in the polymer matrix of the polymer fibers. In examples, the silicone may or may not chemically bond with other polymers in the solid dispersion.

In at least some examples, color may be imparted to the fiber when the fiber is formed (commonly known as dope dyeing). In dope dyeing, the color is added to the fiber as it is being extruded such that the color is integral to the fiber and is not added to the fiber in a post-formation step (e.g., through a piece dyeing step).

The fibers can include virgin fibers (fibers that have not been recycled), and/or recycled fibers. Recycled fibers include “shredded-article fibers” and “re-pelletized-polymer fibers.” As used herein, shredded-article fibers include fibers that are direct by-products of shredding a fiber-containing article (e.g., knit, woven, nonwoven, etc.). In some examples, shredded-article fibers may be derived without pelletizing and extrusion through processes that consume less energy, and as such, textiles that incorporate shredded-article fibers may have a lower carbon footprint. Re-pelletized-polymer fibers include fibers that are extruded from pelletized or chipped by-products derived from polymer-containing sources (e.g., polymer-containing bottles or containers; polymer-fiber articles that are knit, woven, nonwoven; roll goods; textile manufacturing scrap; fiber webs at various stages of carding, lapping, pre-needling, and needling; etc.).

Fibers can have an indefinite length. For example, man-made and synthetic fibers are generally extruded in substantially continuous strands. Alternatively, the fibers can be staple fibers, such as, for example, cotton fibers or extruded synthetic polymer fibers can be cut to form staple fibers of relatively uniform length. The staple fiber can have a length of about 1 millimeter to 100 millimeters or more as well as any increment therein (e.g., 1 millimeter increments). In some examples, the length is between 30 mm and 60 mm. In some examples, the length is about 38 mm. In some examples, the length is about 51 mm. In at least some examples, a nonwoven constructed of staple fibers can be referred to as a nonwoven staple-fiber web or a nonwoven staple-fiber textile.

A fiber can have any of a variety of cross-sectional shapes. Natural fibers can have a natural cross-section, or can have a modified cross-sectional shape (e.g., with processes such as mercerization). Man-made or synthetic fibers can be extruded to provide a strand having a predetermined cross-sectional shape. The cross-sectional shape of a fiber can affect its properties, such as its softness, luster, and wicking ability. The fibers can have round or essentially round cross sections. Alternatively, the fibers can have non-round cross sections, such as flat, oval, octagonal, rectangular, wedge-shaped, triangular, Y-shape, dog-bone, X-shape, clover shape, star shape, penta-lobal, other multi-lobal, multi-channel, saucer shape, serrated, hollow, core-shell, or other shapes.

Fibers can be processed. For example, the properties of fibers can be affected, at least in part, by processes such as drawing (stretching) the fibers, annealing (hardening) the fibers, and/or crimping or texturizing the fibers.

A fiber can be a multi-component fiber, such as one comprising two or more co-extruded polymeric materials. The two or more co-extruded polymeric materials can be extruded in a core-sheath, islands-in-the-sea, segmented-pie, striped, or side-by-side configuration. A multi-component fiber can be processed to form a plurality of smaller fibers (e.g., microfibers) from a single fiber, for example, by removing a sacrificial material or by splitting via entanglement operations (e.g., processing the fiber(s) with needles and/or streams of fluid to cause the components of the fiber to separate).

As used herein, the term “yarn” refers to an assembly formed of one or more fibers, wherein the strand has a substantial length and a relatively small cross-section, and is suitable for use in the production of textiles by hand or by machine, including textiles made using weaving, knitting, crocheting, braiding, sewing, embroidery, or ropemaking techniques. Thread is a type of yarn commonly used for sewing.

When referring to fibers, the term denier or denier per fiber is a unit of measure for the linear mass density of the fiber and more particularly, it is the mass in grams per 9000 meters of the fiber. In one example aspect, the denier of a fiber may be measured using ASTM D1577-07. The dtex of a fiber is the mass of an individual fiber in grams per 10,000 meters of fiber length. The diameter of a fiber may be calculated based on the fiber's denier and/or the fiber's dtex. For instance, the fiber diameter, d, in millimeters may be calculated using the formula: d=square root of dtex divided by 100. In general, the diameter of a fiber has a direct correlation to the denier of the fiber (i.e., a smaller denier fiber has a smaller diameter).

As used in this disclosure, the term “web of fibers” or “fiber web” refers to a layer of fibers prior to undergoing a mechanical entanglement process with one or more other webs of fibers or textiles (e.g., other knit, woven, nonwoven, or braided textile). The web of fibers can include fibers (e.g., staple fibers) that have undergone a carding and lapping process that generally aligns the fibers in one or more common directions that extend along an x, y plane and that achieves a desired basis weight. The web of fibers may also undergo a light needling process or mechanical entanglement process that entangles the fibers of the web to a degree such that the web of fibers forms a cohesive structure that can be manipulated (e.g., rolled onto a roller, unrolled from the roller, stacked, and the like). In examples, a “fiber-web roll good” refers to fibers that have been formed into a cohesive structure (e.g., by carding, lapping, and/or light needling) and rolled onto a core. The web of fibers may also undergo one or more additional processing steps such as printing prior to being entangled with other webs of fibers to form the composite nonwoven textile.

As used herein, the term “entangled web of fibers” when referring to a composite textile refers to a web of fibers after it has undergone mechanical entanglement (e.g., needle entanglement, fluid entanglement (e.g., water-entangled, air-entangled), etc.) with one or more other material layers (e.g., fiber web, continuous filament web, knit textile, woven textile, etc.). As such, a web of entangled fibers may include fibers originally present in the web of fibers forming the layer as well as fibers that are present in other webs of fibers or textiles that have been moved through the entanglement process into the web of entangled fibers. An entangled web of fibers can also be referred to as an “entangled fiber web.” In addition, an entangled web of fibers can also be referred to as a “fiber-web constituent layer,” based on the fiber web being a part, layer, substratum, etc. of a composite textile formed at least in part by the post-entangled layers. Similarly, any layer within a composite textile can be referred to as a “constituent layer,” which can indicate that the layer has been combined as a part, layer, substratum, etc. of the composite textile and that at least some of the material included in the layer might still be present as a component of the given stratum.

Mechanical entanglement processes contemplated herein can include needle entanglement (commonly known as needle punching) using barbed or structured needles (e.g., forked needles), and/or fluid entanglement (via jetted water or air). In aspects contemplated herein, needle punching may be utilized based on the basis weight of the nonwoven staple-fiber web and/or on the ability to push fibers of the nonwoven staple-fiber web through the mesh material panel. In addition, needle punching can, in some instances, result in a fiber web that is less dense, since fluid jetting can have a tendency to more heavily compact the fibers. Needle punching generally uses barbed or spiked needles to reposition a percentage of fibers from a generally horizontal orientation (an orientation extending along an x, y plane) to a generally vertical orientation (a z-direction orientation). Referring to the needle punching process in general, the carded, lapped, and pre-needled webs may be stacked with other carded, lapped, and pre-needled webs and other layers such as a functional layer (e.g., elastomeric layer) and/or other textiles, and passed between a bed plate and a stripper plate positioned on opposing sides of the stacked web configuration.

Barbed needles, which are fixed to a needle board, pass in and out through the stacked web configuration, and the stripper plate strips the fibers from the needles after the needles have moved in and out of the stacked web configuration. The distance between the stripper plate and the bed plate may be adjusted to control web compression during needling. The needle board repeatedly engages and disengages from the stacked web configuration as the stacked web configuration is moved in a machine direction along a conveyance system such that the length of the stacked web configuration is needled.

Aspects herein contemplate using multiple needle boards sequentially positioned at different points along the conveyance system where different needle boards may engage the stacked web configuration from different faces of the stacked web configuration (e.g., an upper face and a lower face) as the stacked web configuration moves in the machine direction. Each engagement of a needle board with the stacked web configuration is known herein as a “pass.”

Parameters associated with particular needle boards may be adjusted to achieve desired properties of the resulting needled nonwoven textile (e.g., basis weight, thickness, and the like). The different parameters may include stitch density (SD) which is the number of needles per cm² (n/cm²) used during an entanglement pass and penetration depth (PD) which is how far the needle passes through the stacked web configuration before being pulled out of the stacked web configuration. Parameters associated with the needle punching process in general may also be adjusted such as the spacing between the bed plate and the stripper plate and/or the speed of conveyance of the stacked web configuration.

Examples of this disclosure contemplate using a barbed needle (a needle having a pre-set number of barbs arranged along a length of the needle) although other needle types are contemplated herein. The barbs on the needle “capture” fibers as the barb moves from a first face to an opposing second face of the stacked web configuration. The movement of the needle through the stacked web configuration effectively moves or pushes fibers captured by the barbs from a location near or at the first face to a location near or at the second face and further causes physical interactions with other fibers helping to “lock” the moved fibers into place through, for example, friction.

It is also contemplated herein that the needles may pass through the stacked web configuration from the second face toward the first face. In examples, the number of barbs on the needle that interact with fibers may be based on the penetration depth of the needle. For example, all the barbs may interact with fibers when the penetration depth is a first amount, and fewer than all the barbs may interact with fibers as the penetration depth decreases.

In further example aspects, the size of the barb may be adjusted based on the denier of fibers used in the web(s). For example, the barb size may be selected so as to engage with small denier (e.g., fine) fibers but not with large denier fibers (or yarns) so as to cause selective movement of the small denier fibers but not the large denier fibers. In another example, the barb size may be selected so as to engage with both small denier and large denier fibers so as to cause movement of both fibers through the webs.

After entanglement, the nonwoven textile may include a first face and an opposite second face which both face outward with respect to an interior of the nonwoven textile and comprise the outermost faces of the nonwoven textile. As such, when viewing the nonwoven textile, the first face and the second face are each fully visible. The first face and the second face may both extend along x, y planes that are generally parallel and offset from each other. For instance, the first face may be oriented in a first x, y plane and the second face may be oriented in a second x, y plane generally parallel to and offset from the first x, y plane.

In some examples, yarns can be formed into a textile or fabric via knitting, weaving, or braiding. These yarns can, in some instances, include silicone-infused fibers. Knitting generally includes a process in which yarns are formed into loops, which are interconnected (e.g., “interlooped”) to form a coherent panel of material, and knitting can include weft knitting or warp knitting. Knitting can include combining one or more different types of stitches. In some examples, knitting can include forming a mesh textile or a mesh material panel.

A “mesh” textile that is formed by knitting generally includes integrally-formed through openings, which can be different from the hole of each stitch. That is, the stitch voids can sometimes include the small voids that are inherently formed by the loop geometry, such as within the head of a knit stitch. In contrast, integrally-formed through openings (e.g., integrally-knitted through openings) can include intentionally engineered openings that are created by stitch manipulation or omission, such as by reconfiguring stitch topology and/or omitting stitches. Integrally-formed through openings are typically larger than stitch voids. Often, integrally-formed through openings are defined by (e.g., circumscribed by) a plurality of stitches (e.g., yarns that are formed into intermeshed stitches) that are organized into a pattern that forms the integrally-formed through openings.

Various stitch types and knitting techniques can be used to form a knit mesh material panel of the present disclosure. For example, a knit mesh can include a tricot warp knit, raschel warp knit, pillar-stitch warp knit, and the like.

In examples, weaving typically includes a process in which two or more sets of yarns (e.g., warp yarns and weft yarns) extending in different directions are interlaced by passing one yarn set alternately over and under yarns of another set. The yarns typically remain substantially straight between interlacement points and do not include loops. A mesh textile can also include a woven mesh textile.

In some examples, a mesh material panel can be formed using other techniques that might not include yarn manipulation. For example, a mesh material panel can include an extruded polymer netting, which is formed by extruding a molten polymer (e.g., thermoplastic polymer) through die heads that deposit intersecting strands (e.g., oriented diagonal or perpendicular to one another), which bond upon solidification (e.g., when cured or cooled).

The term “composite textile” refers to a fabric that includes two or more different textile or material layers (e.g., a fiber web and a functional layer) that are joined into a material with enhanced properties. The layers can include various types of textiles, including knit, woven, nonwoven, braided, films, and the like. The layers can include coatings, sprays, prints, extrusions, films, and other depositions. The layers can be joined by various techniques and structures, such as laminating, coating, extrusion, interweaving, interknitting, entanglement (e.g., fluid and/or needle), and the like. In some examples, a composite textile can include one or more constituent layers. A constituent layer is a material layer within the composite textile. In some examples, a constituent layer can include properties or characteristics that are different from other constituent layers, while still existing as a part of the overall composite textile.

The term “unit area” can describe a portion of a textile used to assess properties of the textile. In some examples, a unit area can include a 1 cm×1 cm (1 cm²), although other sizes can be used, as necessary or dictated based on the property to be assessed. In some examples, a “unit volume” can be used to assess properties of a textile, and a unit volume can include a 1 cm×1 cm×n, where n is a depth or thickness associated with the textile. In some examples, n is the entire thickness of the textile or is the thickness of a layer within the textile (e.g., the thickness of a fiber web within the textile). Other dimensions of unit volumes can also be used, as necessary or dictated based on the property to be assessed.

The term “homogeneous,” as used herein, can describe a fiber and can describe a set of fibers and refers to the quality of having relatively uniform properties. The term “homogeneity” refers to the degree to which a fiber or a set of fibers is homogeneous. Homogeneity can be used to describe a fiber or a fiber web at various stages of processing (e.g., entanglement), such as when the fiber or fiber webs are carded, lapped, pre-needled, entangled with other fiber webs, in a composite nonwoven textile, in a multi-layer pattern piece, in a fiber-web remnant, shredded, re-extruded, and the like. Homogeneity can be based on one or more properties, such as fiber length, denier, diameter, color properties, and chemical composition. Homogeneity can be measured in various manners. In one example, homogeneity can be based on measurements applied to a single fiber. In some examples, homogeneity can describe a blend of fibers (e.g., a homogeneous blend of fibers). In one example, homogeneity can be based on a unit area or unit volume of a fiber web.

Homogeneity can be measured in various manners, which can depend on what property is being measured. For example, homogeneity can be determined by analyzing the fibers within a unit area or unit volume to measure one or more properties (e.g., denier, diameter, shape, length, color property, chemical composition, etc.) of the fibers and determining what percentage of fibers include a common property. In some examples, material composition can be based on one or more various known methods of chemical analysis, and homogeneity can be based on what percentage of material within a unit area includes a common chemical composition. Color property can be determined as described in other parts of this disclosure.

In at least some examples, homogeneity (e.g., a degree or relative amount of homogeneity) can be determined based on an average measured parameter in n number of regions of interest (ROI) having a standard deviation equal to, or less than, “X” units of the average value. In some examples, a property can be considered homogeneous when the standard deviation is 5.0 or less and can be considered highly homogeneous when the standard deviation is 1.0 or less. In at least some examples, n can be at least three or more.

For example, if within a textile (e.g., fiber web, composite nonwoven textile, etc.) four ROIs have a basis weight of 84, 87, 87, and 88, then the average basis weight is 86.5 and the standard deviation is 1.73. In examples, in which homogeneous is based on a standard deviation of 5.0 or less, the textile can be deemed homogeneous based on basis weight. If the basis weights were 84, 85, 85, and 86, then the average basis weight would be 85, the standard deviation would be 0.82, and where a standard deviation of 1.0 or less indicates highly homogeneous, then the textile could be deemed highly homogeneous with respect to basis weight.

The term “color” or “color property” as used herein when referring to the nonwoven textile generally refers to an observable color of fibers that form the textile. Such aspects contemplate that a color may be any color that may be afforded to fibers using dyes, pigments, and/or colorants that are known in the art. As such, fibers may be configured to have a color including, but not limited to red, orange, yellow, green, blue, indigo, violet, white, black, and shades thereof. In one example aspect, the color may be imparted to the fiber when the fiber is formed (commonly known as dope dyeing). In dope dyeing, the color is added to the fiber as it is being extruded such that the color is integral to the fiber and is not added to the fiber in a post-formation step (e.g., through a piece dyeing step). In some examples, a dye or a pigment can be applied to a fiber web via one or more various printing processes, such as screen printing, ink jet printing, sublimation, CO2 dyeing, heat transfer, heat/press printing, and the like.

Examples related to a color further contemplate determining if one color is different from another color. In these aspects, a color may comprise a numerical color value, which may be determined by using instruments that objectively measure and/or calculate color values of a color of an object by standardizing and/or quantifying factors that may affect a perception of a color. Such instruments include, but are not limited to spectroradiometers, spectrophotometers, and the like. Thus, aspects herein contemplate that a “color” of a textile provided by fibers may comprise a numerical color value that is measured and/or calculated using spectroradiometers and/or spectrophotometers. Moreover, numerical color values may be associated with a color space or color model, which is a specific organization of colors that provides color representations for numerical color values, and thus, each numerical color value corresponds to a singular color represented in the color space or color model.

In these aspects, a color may be determined to be different from another color if a numerical color value of each color differs. Such a determination may be made by measuring and/or calculating a numerical color value of, for instance, a first textile having a first color with a spectroradiometer or a spectrophotometer, measuring and/or calculating a numerical color value of a second textile having a second color with the same instrument (i.e., if a spectrophotometer was used to measure the numerical color value of the first color, then a spectrophotometer is used to measure the numerical color value of the second color), and comparing the numerical color value of the first color with the numerical color value of the second color. In another example, the determination may be made by measuring and/or calculating a numerical color value of a first area of a textile with a spectroradiometer or a spectrophotometer, measuring and/or calculating a numerical color value of a second area of the textile having a second color with the same instrument, and comparing the numerical color value of the first color with the numerical color value of the second color. If the numerical color values are not equal, then the first color or the first color property is different from the second color or the second color property, and vice versa.

Further, it is also contemplated that a visual distinction between two colors may correlate with a percentage difference between the numerical color values of the first color and the second color, and the visual distinction will be greater as the percentage difference between the color values increases. Moreover, a visual distinction may be based on a comparison between color representations of the color values in a color space or model. For instance, when a first color has a numerical color value that corresponds to a represented color that is black or navy and a second color has a numerical color value that corresponds to a represented color that is red or yellow, a visual distinction between the first color and the second color is greater than a visual distinction between a first color with a represented color that is red and a second color with a represented color that is yellow.

Various measurements are provided herein with respect to both the joined layers and the resulting composite nonwoven textile. The thickness of the resulting composite nonwoven may be measured using a precision thickness gauge. To measure thickness, for example, the textile may be positioned on a flat anvil and a pressure foot is pressed on to it from the upper surface under a standard fixed load. A dial indicator on the precision thickness gauge gives an indication of the thickness in mm. In examples, a test specimen can include a 10 cm×10 cm sample, and the thickness can be measured at a plurality of locations (e.g., five locations) to determine an average thickness.

In at least some examples, a textile of the present disclosure can include desired basis weight, which can be assessed via ISO3801 (e.g., method 5) testing standard and has the units grams per square meter (gsm).

In at least some examples, a textile of the present disclosure can include desired textile stiffness and can be assessed using ASTMD4032 (2008) testing standard and has the units kilogram force (Kgf). In some examples, by measuring Kgf and displacement, the stiffness in N/mm can be determined.

Fabric growth and recovery can be measured using ASTM2594 testing standard and is expressed as a percentage.

The term “stretch” or “elongation” as used herein means a textile characteristic measured as an increase of a specified distance under a prescribed tension and is generally expressed as a percentage of the original benchmark distance (i.e., the resting length or width). In at least some examples, a textile of the present disclosure can include desired stretch property, which can be assessed using ASTM D2594 (e.g., loop and 5 lb weight).

In some examples, elongation (e.g., % elongation) can be determined relative to an amount of force (N). For example, the elongation % can be measured as the force increases (e.g., 100 mm gauge length at a rate of 300 mm/min). As between two textiles, the elongation % at a given force can be compared to assess relative elongation % at that given force.

In some examples, the force can be gradually increased until the sample fails (e.g., tears, breaks, fractures, or otherwise fails based on the testing procedure), which can be used to determine an ultimate tensile strength, including the maximum tensile stress the textile can withstand before the failure. For example, specimens can be tested using a gauge length of 100 mm. The specimen can be stretched to 2.5 N at a rate of 10 mm/min.

The term “growth” as used herein means an increase in distance of a specified benchmark (i.e., the resting length or width) after extension to a prescribed tension for a time interval followed by the release of tension and is usually expressed as a percentage of the original benchmark distance. For example, ASTM D3107 could be performed to assess growth.

“Recovery” as used herein means the ability of a textile to return to its original benchmark distance (i.e., its resting length or width) and is expressed as a percentage of the original benchmark distance. In at least some examples, a textile of the present disclosure can include desired recovery property, which can be assessed using ASTM D3107.

In at least some examples, a textile of the present disclosure can include desired thermal resistance (e.g., generally corresponding to insulation features), which can be measured using ISO11092 testing standard and has the units of RCT (M2*K/W).

In at least some examples, a textile of the present disclosure can include desired air permeability, which can be assessed via ASTM D737 (e.g., Max. 200 CFM).

In at least some examples, a textile of the present disclosure can include desired bursting strength, which can be assessed via ASTM D6797-2015 (e.g., 25 mm Ball Burster, where textile can withstand min. Ibf.).

In at least some examples, a textile of the present disclosure (e.g., a surface of a textile) can include a coefficient of friction, which can be assessed via one or more tests commonly used to assess coefficient of friction (CoF) on textiles, including parallel and perpendicular orientations, dynamic and static friction, and under dry and wet conditions. Examples of testing standards can include ASTM D1894, ISO 8295, DIN 53375, and the like.

In some examples, reference can be made to a three-dimensional space including an “x” and a “y” and a “z” (e.g., axis, direction, orientation, etc.). Unless otherwise indicated, these references might not include precise relationships to one another and can refer to relative relationships. In some examples, x, y, and z axes orient the composite textile to an x-y plane and a thickness in the z-direction. Any of the textiles or layers described in this disclosure can similarly be described with respect to x, y, and z.

Unless otherwise noted, all measurements provided herein are measured at standard ambient temperature and pressure (25 degrees Celsius or 298.15 K and 1 bar) with the subject textile (e.g., composite textile or a constituent layer of the composite textile) in a resting (un-stretched) state.

Various examples are described below with reference to the drawings, and the structure, relationship, and/or functioning of examples can, in some instances, be better understood by reference to this detailed description. However, examples associated with the subject matter of this application are not limited to those illustrated in the drawings or explicitly described below. The drawings might not necessarily be to scale. In some instances, for clarity, brevity, and/or simplicity details might have been omitted, which does not preclude the inclusion of those details in association with examples of this disclosure.

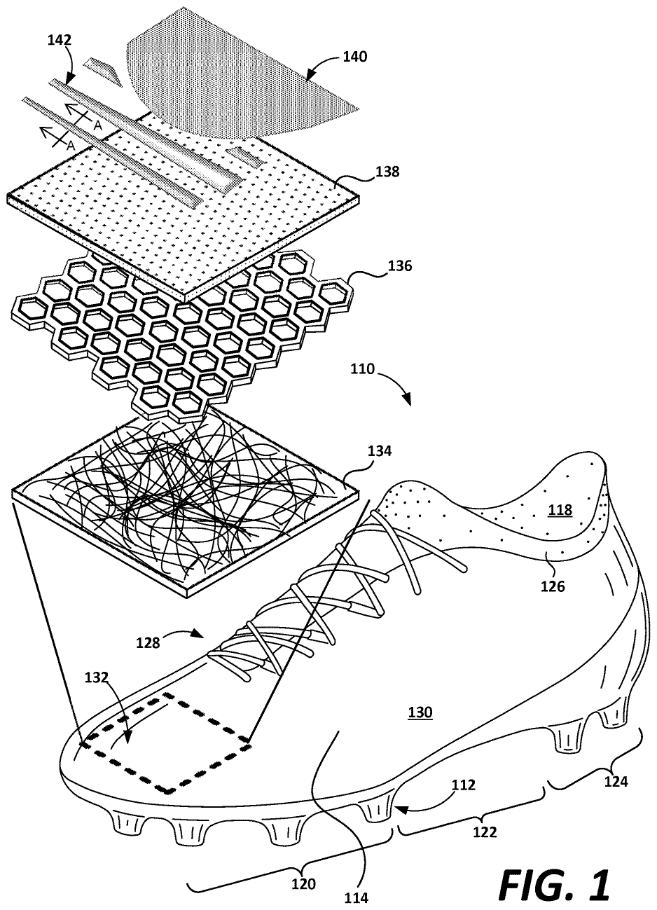

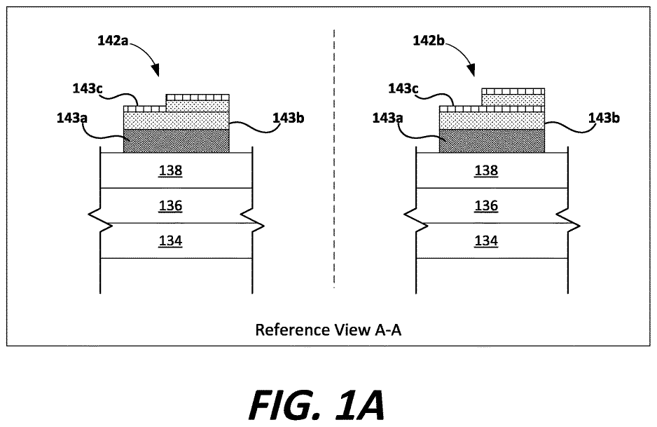

Referring now to FIG. 1, FIG. 1 includes an example of a footwear article 110. The footwear article 110 includes at least two primary elements including a sole structure 112 and an upper 114. When the footwear article 110 is worn (as intended on a foot), the sole structure 112 is typically positioned near the foot plantar surface (e.g., the bottom of the foot). The sole structure 112 may protect the bottom of the foot, and in addition, may attenuate ground-reaction forces, absorb energy, provide traction, and control foot motion, such as pronation and supination. The upper 114 is coupled to the sole structure 112, and together with the sole structure 112, forms a foot-receiving cavity. That is, while the sole structure 112 typically encloses the bottom of the foot (e.g., encloses the space underneath the foot), the upper 114 extends over, and at least partially covers, a dorsal portion of the foot (e.g., the top of the foot or the instep) and secures the footwear article 110 to the foot. The upper 114 includes a foot-insertion opening 118, through which a foot is inserted when the footwear article 110 is put on as the foot is arranged into the foot-receiving cavity.

The footwear article 110 may include a forefoot region 120, a midfoot region 122, a heel region 124, and an ankle region 126. The forefoot region 120, the midfoot region 122, and the heel region 124 extend through the sole structure 112 and the upper 114. The ankle region 126 is located in a portion of the upper 114. The forefoot region 120 generally includes portions of the footwear article 110 corresponding with the toes and the joints connecting the metatarsals with the phalanges. The midfoot region 122 generally includes portions of the footwear article 110 corresponding with the arch area and instep of the foot. The heel region 124 corresponds with rear portions of the foot, including the calcaneus bone. The ankle region 126 corresponds with the ankle. The forefoot region 120, the midfoot region 122, the heel region 124, and the ankle region 126 are not intended to demarcate precise areas of the footwear article 110, and are instead intended to represent general areas of the footwear article 110 to aid in the understanding of various aspects of this specification. In addition, portions of a footwear article may be described in relative terms using these general zones. For example, a first structure may be described as being more heelward than a second structure, in which case the second structure would be more toeward and closer to the forefoot.

The footwear article 110 also has a medial side 128 and a lateral side 130. The medial side 128 and the lateral side 130 extend through each of the forefoot region 120, the midfoot region 122, the heel region 124, and the ankle region 126, and correspond with opposite sides of the footwear article 110, each falling on an opposite side of a longitudinal midline reference plane of the footwear article 110, as is understood by those skilled in the art. For example, the longitudinal midline reference plane may pass through the foremost point of the sole structure and the rearmost point of the sole structure. The medial side 128 is thus considered opposite to the lateral side 130. Typically, the lateral side 130 corresponds with an outside area of the foot (i.e., the surface that faces away from the other foot when the wearer is flat-footed), and the medial side 128 corresponds with an inside area of the foot (i.e., the surface that faces toward the other foot when the wearer is flat-footed). In another aspect, the footwear article 110 includes an anterior portion (e.g., more forward) and a posterior portion (e.g., more rearward), falling on an opposite side of a latitudinal midline reference plane of the footwear article 110, as understood by those skilled in the art. The latitudinal midline reference plane extends perpendicular to the longitudinal midline reference plane and to the ground-surface plane and is spaced evenly between the foremost point of the footwear article 110 and the rearmost point of the footwear article 110. In addition, these terms may also be used to describe relative positions of different structures. For example, a first structure that is closer to the inside portion of the footwear article might be described as medial to a second structure, which is closer to the outside area and is more lateral. In addition, a first structure that is closer to the forward end of the footwear article might be described as anterior to a second structure, which is closer to the rearward end that is more posterior.

The footwear article 110 depicted in FIG. 1 is an example of one type of footwear article including a soccer or football cleat, and examples of the present disclosure can include a variety of different styles and types of footwear articles, such as a running shoe, a baseball shoe, a basketball shoe, a skateboarding shoe, a cycling shoe, an American football shoe, a tennis shoe, a lifestyle shoe, a training shoe, a walking shoe, a hiking shoe, and the like. The examples described herein may also be applied to other footwear types that are considered non-athletic such as dress shoes, loafers, sandals, and work boots. In examples, the sole structure 112 can include one or more sole structures that are secured to the upper 114. The sole structures may include a one-piece plate or a multi-piece plate. In addition, the sole structure 112 can be adapted to the style of footwear article, such that the one or more sole structures can include an outsole, a midsole, a cushioning element, an insole, or any combination of the above including a unitary structure that functions as a midsole and an outsole.

At least a portion of the upper 114 can be constructed of a composite textile 132. In at least some examples, the composite textile 132 includes a nonwoven staple-fiber web 134, a mesh material panel 136, and a film 138. In some examples of this disclosure, the nonwoven staple-fiber web 134 is a first layer; the mesh material panel 136 is a second layer; and the film 138 is a third layer. In addition, the nonwoven staple-fiber web 134 can be an innermost layer (e.g., relative to the mesh material panel 136 and the film 138 and facing towards the foot-receiving cavity), and the film 138 can be an outermost layer (e.g., relative to the nonwoven staple-fiber web 134 and the mesh material panel 136 and facing away from the foot-receiving cavity).

The composite textile 132 includes various properties, at least some of which can depend on the properties of the nonwoven staple-fiber web 134, the mesh material panel 136, and the film 138, and/or the manner in which the layers are combined. In some instances, the properties can depend on properties each individual layer, as well as on the synergies of the layers when combined. In addition, the properties of the layers and the method of constructing the composite textile 132 can be adjusted to tune the desired properties.

For example, the composite textile 132 can include stretch and recovery properties that are well suited for use scenarios in which the wearer's foot exerts forces (e.g., mediolateral forces, fore-aft forces, etc.) on the upper, such as when the wearer quickly changes direction, starts/stops, sprints, jumps and the like. This could include various activities, such as soccer, football, baseball, basketball, distance running, track and field, and the like. In examples, the upper 114 can stretch an amount that provides sufficient support to the wearer when engaging in these activities and can include sufficient recovery to reduce the likelihood of appearing stretched out or loose and to retain the shape of the upper, as well as retain the ability to undergo similar subsequent forces and support the wearer's foot during subsequent movements (e.g., the next time the wearer exerts the forces on the upper).

In some examples, the composite textile 132 can include a desired stiffness, which can impact the break-in period associated with the upper and can contribute to the ability of the upper 114 to conform to the wearer's foot.

In some examples, the composite textile 132 can include a basis weight (gsm) that is conducive to one or more use cases. For example, when playing soccer, the ability of a player to sense and feel the ball touching their foot is important for control, among other things (e.g., when the player is dribbling, passing, shooting, trapping, etc.). As such, the basis weight of the composite textile 132 can be optimized for good ball feel when the footwear article 110 includes a soccer cleat, or similar footwear style. Other material properties can also be controlled to achieve a desired enhanced ball feel, such as compressibility and thickness.

In at least some examples, the composite textile 132 can include various other desired properties, such as a desired amount of air permeability, vapor resistance, and the like. In addition, the composite textile 132 can include an amount of ply adhesion, such as between the film 138 and the other layers.

In at least some examples, the composite textile 132 can provide a platform to add one or more other features or elements, which can be optional. For example, in at least some cases, coating 140 (e.g., topcoat) can be added (e.g., printed via screen printing, digital printing, etc.) to the outer face of the film 138. In some examples, the coating 140 can impart desired surface properties to the composite textile 132. For example, the coating 140 can impart a coefficient of friction, which can be different as compared to the film 138. In some instances, the coating 140 can include a dye or pigment to impart a color property. In some examples, the coating 140 can impart abrasion resistance. In at least some examples, the coating 140 can be applied across the entire upper of the footwear article 110. In some examples, the coating 140 can be applied zonally to portions of the upper of the footwear article 110. In some examples, a first portion of the coating 140 can be applied in one area of the upper, such as in the forefoot region 120 or toe box, and a second portion of the coating 140 can be applied in a different area of the upper, such as the instep or midfoot 122, and the second portion can have different properties than the first portion.

In addition, other materials can also be deposited (e.g., extruded, screen printed, or otherwise applied) onto the outer face of the film 138 to form raised structures or protuberances 142, which can impart various properties, such as strength, stretch resistance, abrasion resistance, aesthetics, ball-control elements (e.g., surface features that can, by imparting a coefficient of friction, increase the ability of the wearer to trap a ball and/or impart spin on a ball when striking), etc. As used herein, the term “protuberance” can describe a discrete or localized projection or raised feature that extends outward and away from a surface. A protuberance can include various dimensional qualities, such as a base area or footprint, height, outline/footprint shape (e.g., circular, elliptical, rectangular, ovular, chevron, etc.), 3D form (e.g., conical, hemispherical, pyramidal, dome-shaped, etc.), and the like.

In some examples, the protuberances 142 can include structures that are extruded onto the film 138. In some examples, the protuberances 142 can include structures that are printed onto the film 138 (e.g., screen printed). For instance, the z-height of the protuberances 142 can be built up by printing one or more layers of on the film 138 on top of one another. In some examples, the protuberances 142 can include structures that are formed by a combination of one or more printed and extruded layers. The protuberances 142 can have various shapes and configurations, such as elongated ridges, circular bumps, geometrically shaped ridges, chevrons, etc. In addition, the protuberances 142 can be applied either across the entire upper in some examples. In other examples, the protuberances 142 can be applied zonally with zonal properties.

In some examples, a texture (not shown in FIG. 1) can be pressed into the film 138 such as when heat and pressure are applied to the film 138 to bond it to the substrate, and the texture can impart a desired look, aesthetic, or functionality to the outer face of the film 138. For example, a transfer sheet can be used with a plate, which is used to apply heat/pressure when bonding the film 138 to the substrate.

In some instances, colorant can be optionally added underneath the film 138, such as to the substrate of the nonwoven staple-fiber web 134 and the mesh material panel 136. For example, the substrate can be printed on (e.g., screen printed, inkjet printed, laser printed, etc.) and/or dye can be sublimatedly added to the substrate (e.g., via CO2 or other sublimation techniques or sublimation mediums). Stated differently, colorant can be added to the nonwoven staple-fiber web 134, to the mesh material panel 136, or to both the nonwoven staple-fiber web 134 and to the mesh material panel 136. In these examples where colorant is optionally added beneath the film 138, the film 138 can function as a protective layer that protects the colorant and increases the durability of the colorant.

In at least some examples, the nonwoven staple-fiber web 134 can have properties that contribute to the overall properties of the composite textile 132, such as the basis weight, stretch and recovery, stiffness, etc. of the composite textile 132. For example, in at least some examples the nonwoven staple-fiber web 134 can include a basis weight that is at least 300 gsm, or at least 350 gsm, or at least 400 gsm, or at least 450 gsm, or at least 500 gsm, or at least 550 gsm. In some examples, the basis weight of the nonwoven staple-fiber web 134 can be below 300 gsm. In some examples, the basis weight is in a range of about 300 gsm to about 550 gsm, or about 300 gsm to about 500 gsm, or about 300 gsm to about 450 gsm, or about 300 gsm to about 400 gsm, or about 300 gsm to about 350 gsm, or about 350 gsm to about 550 gsm, or about 400 gsm to about 550 gsm, or about 450 gsm to about 550 gsm, or about 500 gsm to about 550 gsm, or about 350 gsm to about 500 gsm. In at least some examples, the nonwoven staple-fiber web 134 can include a basis weight of about 400 gsm or about 450 gsm or in a range between 400 gsm and 450 gsm, which can contribute to the composite textile 132 having properties that are desired for use in a soccer cleat. For example, if the basis weight of the nonwoven staple-fiber web 134 is too low, then the upper can feel too thin to the wearer and can feel like there is insufficient protection (e.g., insufficient protection from contact with other objects, such as other cleats, the ball, etc.). In at least some examples, if the basis weight is too high, then the upper 114 can feel too thick and can impede or impair the wearer's ability to feel the ball on their foot (e.g., when trapping, dribbling, passing, shooting, etc.).

In at least some examples, the nonwoven staple-fiber web 134 can include fibers with properties that contribute to the composite textile 132 being well suited for an upper. For example, the fibers can include a size (e.g., denier, dtex, diameter, etc.) that is larger than about 1.0 D. In at least some examples, the size of the fibers can be in a range of about 1.0 D to about 6.0 D, including any incremental value in that range. In some examples, the fiber size is about 1.5 D, or about 2.0 D, or about 2.5 D, or about 3.0 D, or about 3.5 D, or about 4.0 D, or about 4.5 D, or about 5.0 D. In some examples, the fiber size is larger than the component fibers of a splittable multi-component fiber.

In at least some examples, the larger fiber size and/or non-splittable nature of the fibers (e.g., as compared to microfibers) can contribute to various process advantages, such as less needing or other processing (e.g., chemical treatment or otherwise that is otherwise necessary for splitting/separation). In some examples, the larger size (e.g., as compared to microfibers) can contribute to improved peel strength, such as where the film 138 is able to penetrate deeper into portions of the nonwoven staple-fiber web 134 when the composite textile 132 is formed (e.g., deeper as compared to a nonwoven constructed of microfibers in which the fibrous assembly is often denser). In some examples, the larger size (e.g., as compared to microfibers) can contribute to less fiber shedding, which is often experienced by fibers of lower sizes.

In at least some examples, the fibers of the nonwoven staple-fiber web 134 can compositionally include a solid dispersion of a synthetic polymer and a silicone polymer. For example, the fibers can include a solid dispersion of polyester (e.g., PET) and silicone. In these fibers, the synthetic polymer and silicone can be blended in a dispersion prior to extrusion, such that the silicone is infused in the dispersion of the fiber, and is not just a coating on the surface. For example, in some instances, the silicone can be present at room temperature (25 degrees C.) in the form of dispersed, compacted inclusions, which as a result of the thermoplastic processing, e.g. by blending in the melt extruder, are distributed substantially homogeneously in the polymer matrix of the polymer fibers. In some examples, the solid dispersion of polyester and a silicone polymer; a size of about 1.7 dtex (about 1.5 D); a length of about 50 mm (e.g., 51 mm); and a round cross section. This is just one example, and in other examples the synthetic polymer can include other polymers, such as polyamide. In addition, the fiber can include other sizes, lengths, and cross-sectional shapes, such as any of the fiber properties described in this disclosure.

Without being bound by theory, it is believed that these fibers may be less stiff than conventional PET (or rPET) fibers that do not include silicone infused in the fiber, and in turn, it is believed that the nonwoven staple-fiber web 134 might also be less stiff, thereby contributing to a lower stiffness of the composite textile 132. Lower stiffness can contribute to various desired properties, such as more conformed fit, less break-in time, better ball feel, and the like. These fibers are different than, and provide various advantages over, silicone-coated fibers. For example, silicone-coated fibers merely include a fiber made of a synthetic polymer with a silicone coating only on the surface of the fiber (e.g., not infused into the fiber). While silicone-coated fibers are sometimes used in nonwovens or other applications, the silicone-coated fibers can have some disadvantages. For example, silicone-coated fibers can sometimes clog barbs in needles adding time and expense to the manufacturing process. In addition, silicone-coated fibers can be harder to bond to and can be associated with lower ply adhesion between layers. For example, a film (e.g., the film 138) might not bond as well to silicone-coated fibers based on the silicone on the outer surface of the fibers. In some instances, silicone-coated fibers might be more likely to disentangle from other layers, which can contribute to delamination or peeling of the fiber layer, as well as pilling. In contrast to silicone-coated fibers, in examples of the present disclosure that include fibers infused with silicone, the fibers don't include a silicone coating, are less likely to migrate and pill, can form stronger bonds with films and other layers, and are less stiff.

In at least some examples, the nonwoven staple-fiber web 134 is needle-punched (e.g., lightly needled) prior to joining to the mesh material panel 136 (e.g., where joining to the mesh material panel 136 can include needle punching, adhesive bonding, etc.). That is, the nonwoven staple-fiber web 134 can undergo an amount of needle punching (e.g., a stitch density, number of passes, penetration depth, etc.) that can impart various properties to the nonwoven staple-fiber web 134, such as higher stretch (as compared to a web that has not been needled or has been needled to a lesser extent). The needling parameters can be optimized to impart a desired balance of properties, such as by controlling the stitch density, penetration depth, number of passes, direction of needling, etc.

In some cases, the nonwoven staple-fiber web 134 can be treated with a colorant, such as a dye or pigment, prior to being coupled to the mesh material panel 136. For example, the fibers can be dyed at the fiber level and/or the web 134 can be dyed at the web level, such as via sublimation.

The mesh material panel 136 can include various properties and constructions. As used herein, the “mesh material panel” describes planar assembly of a network of members that intersect with one another to form openings. The members can include material segments that are formed by fibers, filaments, yarns, or other elongated members that are intertwined or otherwise arranged to include the positive material structures and the negative openings. Mesh material panels can be constructed from various techniques, such as weaving, knitting, braiding, extruding (e.g., 3D printing, polymer extrusion through a die head, etc.), casting, and the like.

In some examples, the openings can be a consistent size and shape and are arranged in a repeating pattern. In some examples, the size and shape of the openings can vary. In addition, the size and shape of the material segments can also vary. In examples in which the openings and/or the material segments vary, the mesh material panel 136 can be configured to impart zonal properties to different areas, regions, or zones of the upper, such as where varied knit techniques and stitch patterns can be combined in various manners to create zonal properties (e.g., stretch, breathability, etc.).

In examples, in which the mesh material panel 136 includes a knit construction, the knit construction can include stitches that include loops, which form micro-openings or through holes. In addition, a plurality of stitches of the knit construction can be arranged or organized into a pattern to form larger through holes, which can form the openings of the mesh construction. For example, the mesh material panel 136 can be constructed of a warp knit stitch configuration, such as tricot, raschel, pillar-stitch, and the like.

A mesh material panel 136 can have various properties that can contribute to the overall properties of the composite textile 132, such as basis weight, opening size, opening shape, fiber type (e.g., compositional material), stretch and recovery properties, air permeability, stiffness, and the like.

In at least some examples, the mesh material panel 136 can include a warp knit mesh textile. For example, the mesh material panel 136 can include a warp-knit hexagon mesh, a warp-knit diamond mesh, or a warp-knit elliptic mesh. In some examples, the mesh material panel 136 can include a weft-knit mesh, such as using tuck stitches, transfer stitches, etc.

In at least some examples, the mesh material panel 136 can include a knit mesh panel that is heat treated (e.g., heat set), which can contribute to a more stable mesh shape and can dampen or otherwise reduce or diminish stretch properties (e.g., elongation).

The mesh material panel 136 can include various basis weights, and in some examples, the mesh material panel 136 can include a basis weight that is at least 100 gsm, or at least 150 gsm, or at least 200 gsm, or at least 235 gsm, or at least 310 gsm, or at least 410 gsm. In examples, the mesh material panel 136 can include a basis weight that is less than 100 gsm or more than 410 gsm. In some examples, the mesh material panel 136 can include a basis weight that is between about 100 gsm and about 500 gsm, or between about 100 gsm and about 450 gsm, or between about 100 gsm and about 400 gsm, or between about 100 gsm and about 350 gsm, or between about 100 gsm and about 300 gsm, or between about 100 gsm and about 250 gsm, or between about 100 gsm and about 200 gsm, or between about 100 gsm and about 150 gsm, or between about 150 gsm and about 450 gsm, or between about 200 gsm and about 450 gsm, or between about 250 gsm and about 450 gsm, or between about 300 gsm and about 450 gsm, or between about 350 gsm and about 450 gsm, or between about 400 gsm and about 450 gsm, or between about 200 gsm and about 450 gsm, or between about 250 gsm and about 400 gsm, or between about 300 gsm and about 350 gsm.

The mesh material panel 136 can be constructed of different fiber types and yarns, such as fibers/yarns comprising one or more different polymers, including any of the polymers described herein in association with fibers. For instance, in at least some examples, the yarns of the mesh material panel can include polyester or polyamide. In some instances, the yarns of the mesh material panel can include silicone-infused polyester.

The mesh material panel 136 can have various stretch and recovery properties, which can be affected by the structure of the panel, as well as the compositional material. For example, the mesh material panel 136 can have stretch and recover properties that are affected by the style construction (e.g., warp-knit or weft-knit construction based on how stitches interloop with one another) and/or the stretch and recovery properties of the compositional material (e.g., elastomeric properties of the compositional material).

In at least some examples, the mesh material panel 136 can have an elongation at 200N of about 5% to about 25%, or about 5% to about 20%, or about 5% to about 15%, or about 5% to about 10%, or about 10% to about 25%, or about 15% to about 25%, or about 20% to about 25%, or about 10% to about 20%, or about 15%.

In at least one example, the mesh material panel 136 can include a warp-knit hexagon mesh or a warp-knit elliptical mesh with a basis weight of about 310 gsm and constructed of rPET. However, the mesh material panel can include a lighter basis weight or a heavier basis weight or any of the basis weights described above.

In examples, the mesh material panel 136 can be treated with a colorant, such as a dye or pigment, prior to being coupled to the nonwoven layer. For example, the fibers can be dyed at the fiber level, yarns can be dyed at the yarn level, and/or the mesh material panel 136 can be dyed at the textile level. For example, the mesh material panel 136 can be sublimatedly printed at the textile level prior to being coupled to the nonwoven layer. In some examples in which the mesh material panel 136 is treated with a colorant prior to coupling with the nonwoven layer, the colorant can include a design with one or more colors. In such examples, the mesh material panel 136 can include a mesh configuration with a higher coverage percentage and/or a higher basis weight, which as compared to a mesh with a lower coverage percentage and/or lower basis weight can result in better design fidelity. For example, in some embodiments in which a colorant is applied to the mesh material panel 136, the mesh material panel 136 can include a basis weight that is above 200 gsm, whereas in other examples in which the colorant is applied to the fiber web alone and/or to a substrate of the fiber web combined with the mesh material panel, the mesh material panel might include a basis weight that is between 100 gsm and 200 gsm.

In some examples, yarns that are used to construct the mesh material panel 136 can include varied color properties. For example, a first yarn can include a first color and a second yarn can include a second color, which is different from the first color, where the first yarn and the second yarn are knitted together, woven together, or otherwise combined to form the mesh material panel 136.

The film 138 can include various properties, and in general, the film 138 is a continuous solid layer of a polymeric composition that covers the outer surface of the upper 114. The film 138 can include various polymers, such as polyurethane, thermoplastic polyurethane (TPU), and the like, and can provide various functions, such as abrasion resistance, water resistance, aesthetics, and the like. The film 138 can be applied in various manners. For example, the film 138 can be applied as a hotmelt, such as a polyurethane (PU), a thermoplastic polyurethane (TPU), a polyurethane coated on a TPU hotmelt, a polyurethane coated on a PU hotmelt, etc. In some examples, the film 138 can be applied in liquid form, such as a coating that is sprayed on, extruded on, or printed on (e.g., screen printed or otherwise).

In some examples, the film 138 can be relatively clear with little or no added colorant.

The film 138 can include various thicknesses. In examples, the film 138 can include a thickness that is between about 0.1 mm and about 1.0 mm, or between about 0.2 mm and about 1.0 mm, or between about 0.3 mm and about 1.0 mm, or between about 0.4 mm and about 1.0 mm, or between about 0.5 mm and about 1.0 mm, or between about 0.6 mm and about 1.0 mm, or between about 0.7 mm and about 1.0 mm, or between about 0.8 mm and about 1.0 mm, or between about 0.9 mm and about 1.0 mm, or between about 0.1 mm and about 0.9 mm, or between about 0.1 mm and about 0.8 mm, or between about 0.1 mm and about 0.7 mm, or between about 0.1 mm and about 0.6 mm, or between about 0.1 mm and about 0.5 mm, or between about 0.1 mm and about 0.4 mm, or between about 0.1 mm and about 0.3 mm, or between about 0.1 mm and about 0.2 mm, or between about 0.2 mm and about 0.5 mm, or between about 0.2 mm and about 0.4 mm.

The film 138 can have various other properties. In some examples, the film 138 can have micropores to enhance breathability. In some examples, the film 138 can be transparent. In some cases, the film 138 can have a colorant (e.g., where a dye or pigment is mixed with the polymeric dispersion prior to application). In some examples, the film 138 can include a texture and/or 3D structures or relief on the outer face, such as where a texture is embossed/debossed when pressure and heat is applied to the film while bonding the film 138 to the upper 114. A 3D structure or relief can also be created by the mesh material panel 136 beneath the film 138, such as where the film 138 conforms around the positive material segments and openings.

In at least some examples, the film 138 can provide a substructure for the application of additional features. For example, a coating 140 (e.g., topcoat) can be applied (e.g., screen print, inkjet print, laser print, etc.) to the outer face of the film 138, and/or protuberances 142 can be deposited (e.g., extruded or screen printed) onto the outer face.

In examples, the coating 140 and/or the protuberances 142 can be screen printed as “printed structures” onto the film 138, and the printed structures can include a print media material as described herein.

In accordance with at least some examples of this technology, the print media material can include an aqueous polyurethane dispersion (e.g., such as a polyether polyurethane dispersion). As some more specific examples, the print media material may include: (a) an aqueous compact resin of polyurethane in water having a high solids content (e.g., at least 40% solids); (b) a cross-linking material (e.g., a carbodiimide, an isocyanate, etc.); and (c) a rheological modifier (e.g., a thickening agent, etc.). In some examples, the print media material can include an alcohol (e.g., an aminoalkyl alcohol). In some examples, the print media material can include a debubbling agent or defoamer (e.g., mineral oil).

Additionally, in at least some examples, the print media material further may include one or more pigments, e.g., to produce a desired color. Alternatively, in other examples, the print media material need not include pigments. In such examples, the printed structures may have the resultant color of their remaining ingredients and/or may have a generally translucent, clear, and/or colorless appearance.

In at least some examples of this technology, a print media material, e.g., including the ingredients above, may have a solids content of at least 40% solids, and in some examples, at least 45% solids, at least 50% solids, at least 55% solids, between 40% and 70% solids, between 45% and 68% solids, between 50% and 68% solids, between 55% and 68% solids, between 55% and 62%, or between 60% and 68% solids.

Additionally or alternatively, the print media material, e.g., including the ingredients above, can include a non-Newtonian fluid, e.g., that displays reduced viscosity when subjected to shear forces. Additionally or alternatively, the print media material, e.g., including the ingredients above, may comprise a polyurethane dispersion (e.g., a polyether polyurethane dispersion). Additionally or alternatively, the solid particles (e.g., the polyurethane particles and/or polyether polyurethane particles) in the print media material, e.g., including the ingredients above, may have an average diameter of 20 to 40 microns (and in some examples, 25 microns to 35 microns and/or an average of about 30 microns).

In at least some examples of this technology, at least when not exposed to shear forces, the print media material (e.g., including the ingredients above) may have a viscosity within a range of 550 centipoise to 130,000 centipoise. As some additional examples, when not exposed to shear forces, the print media mixture and/or the print media material may have a viscosity of at least 80,000 centipoise, at least 85,000 centipoise, at least 90,000 centipoise, within a range of 80,000 to 140,000 centipoise, within a range of 85,000 to 140,000 centipoise, within a range of 90,000 to 135,000 centipoise, within a range of 95,000 to 135,000 centipoise, or within a range of 100,000 to 135,000 centipoise.

In at least some examples of this technology, the print media material, e.g., including the ingredients above, may be restricted substances list (“RSL”) compliant, contain low amounts of volatile organic compounds (“VOCs”), and/or contain no VOCs.

As noted above, the print media material in accordance with at least some examples of this technology includes an aqueous compact resin of polyurethane in water having a high solids content. This aqueous resin may comprise a polyurethane dispersion (e.g., including a polyether polyurethane dispersion) and/or comprise an aliphatic polyurethane. The aqueous resin may be RSL compliant, contain low amounts of VOCs, and/or contain no VOCs.

In at least some examples of this technology, the aqueous resin may have a solids content of at least 40% solids, and in some examples, at least 45% solids, at least 50% solids, between 40% and 65% solids, between 45% and 60% solids, between 50% and 60% solids, or between 52% and 58% solids.

In at least some examples of this technology, the aqueous resin ingredient may have a viscosity within a range of 3000 centipoise to 10,000 centipoise (prior to its fabrication into the print media material). In some examples, this viscosity may be within a range of 3500 centipoise to 9000 centipoise, within a range of 4000 centipoise to 8000 centipoise, or within a range of 4500 centipoise to 8000 centipoise. If necessary or desired, a thickening agent (e.g., rheological modifier) may be included in the final print media material to form the print media material to the final viscosity for the printing process.

Additionally or alternatively, in at least some examples of this technology, the aqueous resin ingredient may have a pH within a range of 8.5 to 10.5, and in some examples, within a range of 9 to 10.

Additionally or alternatively, in at least some examples of this technology, the aqueous resin ingredient may form from 75% by weight to 97% by weight of the overall print media material. As some additional ranges, the aqueous resin content may be within a range of 80% by weight to 95% by weight, within a range of 82% by weight to 92% by weight, or within a range of 84% by weight to 90% by weight (all percentages based on the total weight of the print media material).

As noted above, the print media material in accordance with at least some examples of this technology may include a cross-linking material. Any suitable cross-linking material may be used in different specific examples of this technology. As some more specific examples, the cross-linking material may comprise a carbodiimide (e.g., a polycarbodiimide) or an isocyanate (e.g., a polyisocyanate, such as a blocked aliphatic isocyanate).

As some additional examples, the cross-linking material used may provide a long pot life for the print media material (e.g., for better, long-term storage of print media material). “Pot life” refers to the length of time it takes for the viscosity of the mixed material to increase to the point that it can no longer be applied by the application method to be used. In some examples, cross-linking material can impart desired stretch properties to the print media material, such as the ability to repeatably stretch without cracking or otherwise losing some property integrity. Some more specific examples of cross-linking materials that may be used in accordance with at least some examples of this technology include polycarbodiimide cross-linking materials, e.g., VOC-free, water-based, polycarbodiimide crosslinkers, such as Permutex® XR-5508 available from Stahl.

As some additional examples, polyisocyanate cross-linking materials useful in at least some examples of this technology may comprise blocked aliphatic polyisocyanate cross-linkers, such as Permutex® XR-22-903 available from Stahl.

Additionally or alternatively, in at least some examples of this technology, the cross-linking material may be present within a range of from 1.5% by weight to 5.5% by weight of the overall print media material. As some additional ranges, the cross-linking material may be within a range of 1.75% by weight to 5% by weight, within a range of 2% by weight to 4.5% by weight, or within a range of 2.5% by weight to 4.2% by weight (with these percentages based on the total weight of the print material). Still additionally or alternatively, in at least some examples of this technology, the cross-linking material may be present within a range of from 2% by weight to 6% by weight based on the weight of the aqueous resin present in the overall print media material (and in some examples, within a range of 2.5% by weight to 5.5% by weight, or within a range of 3% by weight to 5% by weight (with these weight percentages based on the weight of the aqueous resin present in the overall print media material)).

As noted above, the print media material in accordance with at least some examples of this technology may include an alcohol. While not wishing to be bound by any specific theory of operation, in at least some examples, the alcohol (when present) may help control and/or tune the water evaporation rate from the print media material, may help control and/or tune pH, may help with dispersency, etc.

As some specific examples, the alcohol may comprise an aminoalkyl alcohol, such as an aminomethyl propanol (e.g., 2-amino-2-methyl-1-propanol). Such alcohol ingredients are commercially available from various suppliers.

Additionally or alternatively, in at least some examples of this technology, the alcohol (e.g., aminoalkyl alcohol) may be present within a range of from 0.075% by weight to 4.5% by weight of the overall print media material. As some additional ranges, the alcohol content may be within a range of 0.1% by weight to 4% by weight, within a range of 0.15% by weight to 2% by weight, within a range of 0.2% by weight to 1% by weight, or within a range of 0.25% by weight to 0.65% by weight (with these percentages based on the total weight of the print media material). Still additionally or alternatively, in at least some examples of this technology, the alcohol may be present within a range of from 0.1% by weight to 5% by weight based on the weight of the aqueous resin present in the overall print media material (and in some examples, within a range of 0.15% by weight to 4% by weight, within a range of 0.2% by weight to 2.5% by weight, within a range of 0.25% by weight to 1.5% by weight, or within a range of 0.3% by weight to 0.75% by weight (with these weight percentages based on the weight of the aqueous resin present in the overall print media material)).

As noted above, the print media material in accordance with at least some examples of this technology may include a rheology modifier. The rheological modifier (e.g., a thickening agent), when present, allows one to formulate the final print media material to a final viscosity for use in systems and methods in accordance with aspects of this technology. Increasing an amount of thickening agent in the print media material may increase viscosity and decreasing an amount of thickening agent in the print media material may decrease viscosity.

Any type of rheological modifier (e.g., thickening agent) may be used in various different examples of this technology (e.g., provided desired flow and/or screen-printing functionality is maintained). As some more specific examples, thickening agent may comprise an acrylic thickener material, e.g., an acid-containing acrylic copolymer emulsion (e.g., having a dry solids content of 24-26% and a pH of 4-5). In some examples, a thickening agent/rheology modifier can include a pH associative PU-based thickener. One specific thickening agent/rheology modifier that may be used in accordance with at least some examples of this technology comprises the acrylic thickener Permutex® RM-4409, available from Stahl.

Additionally or alternatively, in at least some examples of this technology, the thickening material/rheology modifier (e.g., an acrylic thickening agent) may be present within a range of from 0.25% by weight to 5% by weight of the overall print media material. As some additional ranges, the thickening material/rheology modifier content may be within a range of 0.5% by weight to 5% by weight, within a range of 1% by weight to 5% by weight, within a range of 2% by weight to 4.5% by weight, or within a range of 2.5% by weight to 4% by weight (with these percentages based on the total weight of the print media material). Still additionally or alternatively, in at least some examples of this technology, the thickening material/rheology modifier may be present within a range of from 0.5% by weight to 6% by weight based on the weight of the aqueous resin present in the overall print media material (and in some examples, within a range of 0.5% by weight to 5% by weight, within a range of 1% by weight to 4.75% by weight, within a range of 1.5% by weight to 4.5% by weight, or within a range of 2% by weight to 4.25% by weight (with these weight percentages based on the weight of the aqueous resin present in the overall print media material)).

In at least some examples, the print media material can include a debubbling agent or a defoamer. Any type of defoamer or debubbling agent may be used in various different examples of this technology. In at least some examples, the print media material can include a mineral oil debubbling agent.

As noted above, the print media material in accordance with at least some examples of this technology may include one or more pigments, e.g., to produce a desired color. Suitable pigments are conventionally known and commercially available.

Additionally or alternatively, in at least some examples of this technology, the pigment(s) may be present within a range of from 1% by weight to 10% by weight of the overall print media material. As some additional ranges, the pigment(s) content may be within a range of 1.5% by weight to 9% by weight, within a range of 2% by weight to 8% by weight, or within a range of 2.5% by weight to 7.5% by weight (with these percentages based on the total weight of the print media material). Still additionally or alternatively, in at least some examples of this technology, the pigment(s) may be present within a range of from 1.25% by weight to 12% by weight based on the weight of the aqueous resin present in the overall print media material (and in some examples, within a range of 1.75% by weight to 10% by weight, within a range of 2.5% by weight to 8% by weight, or within a range of 3% by weight to 7% by weight (with these weight percentages based on the weight of the aqueous resin present in the overall print media material)). The specific pigment used and/or the amounts thereof also may affect the viscosity of the final mixture/dispersion (and/or may be used to alter and/or control the viscosity).

The coating 140 is an example of a print structure and can have various properties. In at least some examples, the coating 140 can include a print media material, as described above. In examples, the coating 140 can be transparent (e.g., clear), although a colored coating could be used in other specific examples of this technology. In at least some instances, color properties associated with the film 138, the mesh material panel 136, and/or the web 134 can be seen through the coating 140. In examples, the coating 140 can impart one or more various properties, such as abrasion resistance, modified coefficient of friction (e.g., relative to the film 138), and the like.

In some examples, the coating 140 includes an aqueous polyurethane dispersion (e.g., such as a polyether polyurethane dispersion), e.g., of the types described above for the print media material. As some more specific examples, the coating 140 may include: (a) an aqueous compact resin of polyurethane in water having a high solids content (e.g., at least 40% solids), e.g., of the types described above for the print media material; (b) a cross-linking material (e.g., a carbodiimide, an isocyanate, etc.), e.g., of the types described above for the print media material; and/or (c) a rheological modifier (e.g., a thickening agent, etc.), e.g., of the types described above for the print media material. The coating 140 can, in some examples, include an alcohol (e.g., an aminoalkyl alcohol), e.g., of the types described above for the print media material. The coating 140 can, in some instances, include a debubbling agent or a defoamer, such as mineral oil.

In at least some examples, the coating 140 can include an amount of a rheological modifier that allows the coating 140 to be screen printable. In some examples, the rheological modifier may comprise: (a) less than 1% by weight (based on the total weight of the mixture), (b) less than 0.8% by weight (based on the total weight of the mixture), and/or (c) an appropriate amount of rheological modifier to make the viscosity of the overall mixture in the range of 10,000 centipoise to 15,000 centipoise (and in some examples, in the range of 11,000 centipoise to 13,000 centipoise). The amount(s) of the other ingredients in the aqueous dispersion also may be adjusted, if necessary, to give the dispersion a proper viscosity and/or other properties to enable screen printing (if screen printing is the intended application method).

As noted above, the coating 140 may be transparent, e.g., no pigment may be needed. Additionally or alternatively, if desired, a matting agent may be provided within the aqueous polyurethane dispersion applied as coating 140, e.g., to give the coating 140 more of a matte finish (e.g., less shiny). As some more specific examples, the coating 140 may include silica as a matting agent, e.g., present in an amount up to 4% (based on a total weight of the mixture to be applied as the coating 140). In some examples, the coating 140 can include about 3% by weight of silica.

In at least some examples of this technology, the amounts of the various ingredients may be modified to produce an overall aqueous dispersion for the coating 140 that is screen printable. As some more specific examples, the amount of the various ingredients will be controlled so that the viscosity of the overall mixture is in the range of 10,000 centipoise to 15,000 centipoise (and in some examples, in the range of 11,000 centipoise to 13,000 centipoise). Viscosity control and adjustment may be accomplished, e.g., by adjusting the amount of rheological modifier, matting agent, and/or other components used in making the mixture to be screen printed for the coating 140.

Other ways of applying the coating 140 may be used in other specific examples of this technology. For example, spraying, dipping, and/or other coating methods may be used to apply the coating 140 to the film 138.

In some examples, the coating 140 can cover (by surface area) at least 80% of the film 138, or in some examples at least 90% of the film, or in some examples at least 95% of the film 138. In some examples, the coating 140 need not completely cover the film 138. Rather if desired, the coating 140 may be applied only where its properties (e.g., enhanced bonding, increased coefficient of friction, etc.) are desired for the footwear article 110.

In some examples, the coating 140 can be positioned in at least a forefoot area 120 and/or a midfoot area 122. In some examples, the coating 140 can be positioned in a forefoot area 120 and/or a midfoot area 122 and omitted from one or more other regions of the footwear article 110. In some examples, the coating 140 can be positioned along at least a portion of the medial side of the footwear article 110 (e.g., medial forefoot, medial midfoot, or any combination thereof). In some examples when the coating 140 is along at least a portion of the medial side, the coating 140 can be omitted from at least a portion of the lateral side, and vice versa.

In at least some examples, the coating 140 that is applied in only some portions of the footwear article 110 can include silica (e.g., present in an amount up to 4%), which can reduce the gloss of the coating and increase the matte, while also reducing the coefficient of friction. In at least some instances, this zonal feature can be used to tailor the manner in which the surface of the upper 114 engages a ball (e.g., football or soccer ball). For example, if a higher coefficient of friction is desired in a particular zone (e.g., for producing a grippier feel), then the coating 140 might include lower amounts of silica (e.g., as low as no silica), whereas if a lower coefficient of friction is desired in a particular zone (e.g., for producing a less grippy feel), then the coating 140 might include higher amounts of silica (e.g., up to 4% by weight). Relative coefficient of friction (e.g., higher or lower) associated with the coating 140 can be relative to the film 138, relative to another region of the upper 114 with the coating 140, or any combination thereof.

In at least some examples, the upper 114 can include a first layer of the coating 140 with a first coefficient of friction and a second layer of the coating 140 with a second coefficient of friction, which is different from the first coefficient of friction. In some examples, the first layer and the second layer might not overlap. In some examples, the first layer and the second layer can at least partially overlap. The protuberances 142 are an example of a print structure and can have various properties.

In at least some examples, the protuberances 142 can include a print media material, as described above. In examples, the protuberances 142 can be transparent (e.g., clear), colored (e.g., can include a pigment), or any combination thereof. For example, the protuberances 142 can include one or more layers that are transparent and one or more layers that are colored. In examples, the protuberances 142 can impart one or more various properties, such as abrasion resistance, modified coefficient of friction (e.g., relative to the film 138), and the like.

In some examples, the protuberance 142 includes an aqueous polyurethane dispersion (e.g., such as a polyether polyurethane dispersion), e.g., of the types described above for the print media material. As some more specific examples, the protuberance 142 may include: (a) an aqueous compact resin of polyurethane in water having a high solids content (e.g., at least 40% solids), e.g., of the types described above for the print media material; (b) a cross-linking material (e.g., a carbodiimide, an isocyanate, etc.), e.g., of the types described above for the print media material; and/or (c) a rheological modifier (e.g., a thickening agent, etc.), e.g., of the types described above for the print media material. The protuberance 142 can, in some examples, include an alcohol (e.g., an aminoalkyl alcohol), e.g., of the types described above for the print media material. The protuberance 142 can, in some instances, include a debubbling agent or a defoamer, such as mineral oil.

In at least some examples, the protuberances 142 can include an amount of a rheological modifier that allows the protuberances 142 to be screen printable. In some examples, the rheological modifier may comprise: (a) less than 3% by weight (based on the total weight of the mixture), (b) less than 2.5% by weight (based on the total weight of the mixture), (c) less than 2.0% by weight (based on the total weight of the mixture), (d) less than 1.5% by weight (based on the total weight of the mixture) and/or (e) an appropriate amount of rheological modifier to make the viscosity of the overall mixture in the range of 60,000 centipoise to 110,000 centipoise (and in some examples, in the range of 70,000 centipoise to 100,000 centipoise). In some examples, a lower amount of rheological modifier can be added, or little to no rheological modifier is added to make the viscosity of the overall mixture in the range of 4,500 centipoise to 7,500 centipoise (and in some examples, in the range of 5,000 centipoise to 6,000 centipoise). The amount(s) of the other ingredients in the aqueous dispersion also may be adjusted, if necessary, to give the dispersion a proper viscosity and/or other properties to enable screen printing (if screen printing is the intended application method).

In at least some examples, the protuberances 142 can include a coefficient of friction configured to impart desired properties to one or more zones of the upper 114. For example, the protuberances 142 can impart a grip property, which can be used to tailor the manner in which the upper 114 engages a ball, such as a soccer ball (e.g., football). The coefficient of friction can result from properties of the base polymer the print media material, from the shape and size of the protuberances 142, from the arrangement of multiple protuberances 142, or any combination thereof.

In examples, the protuberances 142 can have various shapes and configurations, such as elongated ridges, circular bumps, geometrically shaped ridges, chevrons, etc. In addition, the protuberances 142 can include various z-heights, which can be measured from the outer surface of the film 138. In at least some examples, the z-height can be at least 0.25 mm (and in some examples, at least 0.30 mm). In some instances, a z-height of about 0.30 mm or higher can include a Stoll abrasion rating of at least 1600 cycles.

In examples, the protuberances 142 can include one or more layers of print media material. For example, the protuberances 142 can each include one or more layers of print media material that have been screen printed one on top of another. In at least some examples, the one or more layers can include one or more different properties. In examples, the one or more layers can be used to build up the z-height of the protuberances 142 to about 0.30 mm or higher. In some examples, the z-height of the protuberances 142 can be about 0.30 mm or higher when the protuberances 142 are screen printed onto the film 138, and the protuberances 142 can be compressed to a shorter z-height when the film is heat pressed onto the substrate (e.g., the fiber web 134 mechanically entangled with the mesh material panel 136).

In examples shown in FIG. 1A, reference view A-A depicts schematics of cross sections of a first protuberance 142a and a second protuberance 142b. The first protuberance 142a includes one example arrangement of a first layer 143a, a second layer 143b, and a third layer 143c, which could be on the film 138 (e.g., after being screen printed on the film 138). The second protuberance 142b includes another example arrangement of a first layer 143a, a second layer 143b, and a third layer 143c, which could be on the film 138 (e.g., after being screen printed on the film 138). In some examples, a protuberance 142 can include fewer layers, such as a first layer and a second layer. In some examples, a protuberance 142 can include more layers.

The layers (e.g., 143a, 143b, and 143c) of a protuberance 142 can, in some instances, include one or more different properties. For example, a first layer can include a first pigment having a first color, and a second layer can include no pigment or can include a second pigment having a second color that is different from the first color. In examples, the first layer might not include a pigment or might include lower amounts of a pigment, as compared to the second layer which might include more of the pigment.

In some examples, a first layer can include a first viscosity (e.g., when screen printed and based on an amount of a rheological modifier), and a second layer can include a second viscosity that is different from the first viscosity (e.g., where each layer can include a different amount of the rheological modifier). Stated differently, the first layer can include a different amount of rheological modifier by weight as compared to the second layer. For example, the first layer can include a higher amount of the rheological modifier, which can contribute to a viscosity of about 100,000 centipoise when the first layer is printed, and the second layer can include a lower amount of the rheological modifier, which can contribute to a viscosity of about 70,000 centipoise when the second layer is printed.

In some examples, a first layer can include a first surface area, and a second layer can include a second surface area, which is smaller than the first surface area. For instance, the first layer (with a larger surface area) can be a base layer or lower layer that is between the second layer and the film 138.

In at least some examples, the protuberances 142 can include at least a first layer and a second layer that each include the print media material, and the first layer can be positioned between the second layer and the film 138. One or more of the first layer and the second layer can include a pigment. In some examples, the first layer can be coupled directly to the film 138. In some examples, one or other layers (e.g., base layer with generic screen print ink formulation) can be positioned between the first layer and the film 138. In at least some examples, the first layer includes the print media material, including a higher amount of the rheological modifier (e.g., contributing to a viscosity in a range of about 90,000 centipoise to about 110,000 centipoise when printed, or in some examples about 100,000 centipoise). The second layer can, in some examples, include a lower amount of the rheological modifier (e.g., contributing to a viscosity in a range of about 60,000 centipoise to about 80,000 centipoise when printed, or in some examples about 70,000 centipoise).

In at least some examples, the protuberances 142 can include a third layer that can include the print media material, and the second layer can be positioned between the third layer and the first layer. In addition, the third layer including the print media material can include one or more different properties as compared to the second layer and/or as compared to the first layer. For example, the third layer can include a lower amount of the rheological modifier and/or a different color (e.g., different pigment or no pigment). In some examples, the third layer can include a lower amount of the rheological modifier, which can contribute to a viscosity in a range of about 4,000 centipoise to about 7,000 centipoise when the third layer is printed (and in some examples about 5,000 centipoise to about 6,000 centipoise). In some examples, the third layer can include a topcoat, which can in some instances be a clear topcoat.

In at least some examples, constructing the protuberances 142 to include layers with more rheological modifier (e.g., thickener or thickening agent) closer to the film 138 with layers of the print media material having lower amounts of rheological modifier stacked on top thereof allows the protuberances 142 to be built up to a desired z-height (e.g., with a fewer number of screen print passes) and to also have a desired finish on the outermost parts of the protuberances 142 (e.g., where the desired finish is imparted by the layer(s) with lower amounts of rheological modifier).

In some examples, one or more other elements can be included in the composite textile 132. For example, a lower basis weight nonwoven layer can be arranged between the film 138 and the mesh material panel 136 (e.g., a nonwoven having a basis weight that is equal to or less than half of the basis weight of the nonwoven layer 134).

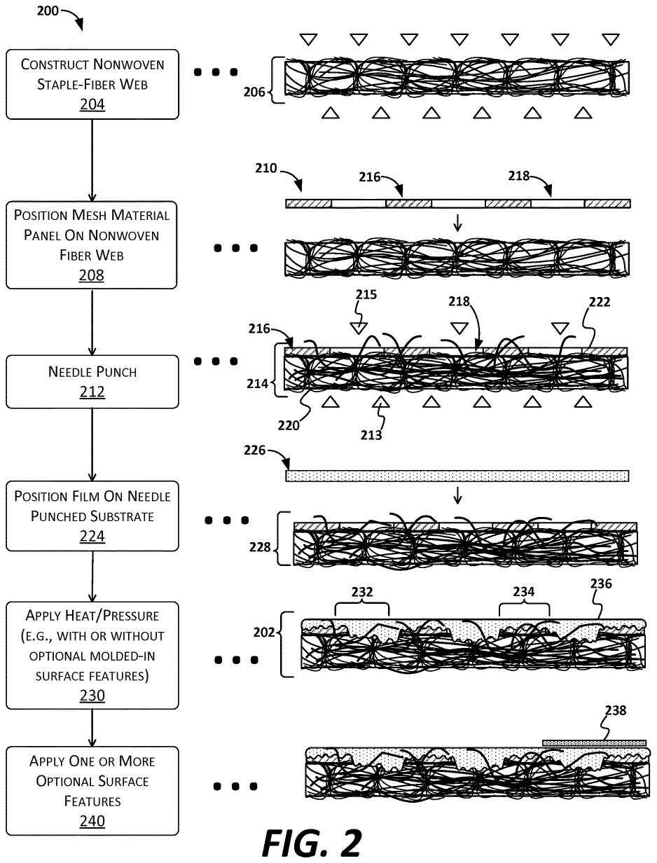

The composite textile 132 can be constructed in various manners, and referring to FIG. 2, a series of steps are outlined in association with an example method 200 for constructing a composite textile 202. Examples of articles and structures that are formed during operations related to the method 200 are depicted in FIG. 2, and at least some examples of the present disclosure include those articles and structures. Those articles or structures can be claimed as part of the claimed invention, separately from, or in combination with, the method 200 and the operations.

In at least some instances, step 204 can include constructing a nonwoven staple-fiber web 206 (e.g., which could be the same nonwoven staple-fiber web 134 described with respect to FIG. 1). For example, staple fibers can be carded, lapped, and in some cases needled (e.g., pre-needled or pre-entangled). In at least some examples, the needling parameters are optimized to impart desired properties to the composite textile 202. That is, the needling parameters can affect various properties of the nonwoven staple-fiber web 206, which in turn can affect the properties of the composite textile 202.

In at least some examples, the step 204 can include a stitch density in a range of about 1000 to about 2000. In some examples, the stitch density can be lower than 1000. In some instances, the stitch density can be higher than 2000. This stitch density can be important to impart some increased elongation properties to the nonwoven staple-fiber web 206. Stated differently, prior to undergoing needling in step 204, the carded web can include a lower amount of elasticity, as most fibers are oriented in the x-y plane with a lower amount of fibers having segments oriented in the z-direction. By needling the carded web, the needles push portions of the fibers in the z-direction, which in turn can increase the elongation properties of the web (e.g., the increase in % length the web experiences when subjected to a prescribed load). This in turn can decrease the extent to which the elongation or stretch properties of the nonwoven staple-fiber web 206 are a limiting factor in the composite textile 202 (e.g., in some cases, the elongation or stretch properties of the nonwoven staple-fiber web 206 might still be a limiting factor, but it is to a lesser extent when the web has been needled as opposed to when it has not been needled). In at least some instances, it may be desirable for the composite textile 202 to include lower elongation, in which case the stitch density at step 204 can be lower and/or possibly zero (no needling). In some cases, it may be desirable for the composite textile 202 to include higher elongation, in which case the stitch density at step 204 can be higher (e.g., at least 1000 or at least 1250 or at least 1500).

In examples, step 208 can include stacking a mesh material panel 210 on the nonwoven staple-fiber web 206. For example, both layers can be rolled goods that are arranged on a needle punch line and stacked so that needles can engage the layers from the top and/or bottom. In at least some cases, tension can be applied to each layer.

Step 212 can include, in some examples, needle punching the stack 214 of the nonwoven staple-fiber web 206 and the mesh material panel 210. For example, the web-side needles 213 can be inserted into the stack from the side of the nonwoven staple-fiber web 206 and traversed towards the mesh material panel 210, such that the needles 213 drive fibers from the nonwoven staple-fiber web 206 and push them through the mesh material panel 210. In at least some cases, the fibers of the nonwoven staple-fiber web 206 are pushed through the middle of material segment portions 216 of the mesh material panel 210 (e.g., as opposed to being pushed through the openings 218 of the mesh). For example, where the material segment portions are constructed of knit stitches, the fibers can be pushed through the loops of the stitches and/or between yarn segments of adjacent stitches, such that the fibers are frictionally retained in the material segments 216. In at least some examples, in step 212 the web-side needles 213 can also push fibers through the openings 218 of the mesh material panel 210.

In examples, step 212 can include needle punching from the direction of the mesh material panel 210, such that the mesh-side needles 215 pass from the direction of the mesh material panel 210 and towards the nonwoven staple-fiber web 206. Among other things, this can push fibers (fiber segments) oriented on the outer face of the mesh material panel 210 back through the material segments 216 and/or the openings 218 and into the nonwoven staple-fiber web 206. In at least some cases, needle punching from the side of the mesh material panel 210 can entangle the fibers around one or more yarns of the mesh material panel 210 and couple the nonwoven staple-fiber web 206 to the mesh material panel 210.

In some examples, fluid entanglement can be ineffective at sufficiently entangling the fibers of the nonwoven staple-fiber web 206 with the mesh material panel 210. For example, where the nonwoven staple-fiber web 206 includes a higher basis weight (e.g., at least 300 gsm or at least 400 gsm or at least 450 gsm), fluid entanglement may not be effective at pushing through the entire web and through the material segments 216.

In at least some examples, the needling parameters associated with step 212 are optimized to impart desired properties to the composite textile 202 and to achieve desired properties of the nonwoven staple-fiber web 206, the mesh material panel 210, and the stack 214. For example, the stitch density and/or penetration depth can be programmed to achieve a sufficient coupling between the nonwoven staple-fiber web 206 and the mesh material panel 210 and to also not degrade the integrity of the mesh material panel 210. For example, the stitch density and/or penetration depth might be limited to minimize potential breaking or tearing of the yarns of the mesh material panel 210 (e.g., from being contacted by the tips and/or barbs of the needles).

In some examples, the stitch density associated with the needles 213 is higher than the stitch density associated with the needles 215. Among other things, this can result in a higher number of needle penetration openings on the web-side face 220 of the stack 214 as compared to the mesh-side face 222 of the stack 214. In addition, this can increase the likelihood that a sufficient number of fiber segments will be frictionally engaged in the material segments 216 to both couple the nonwoven staple-fiber web 206 to the mesh material panel 210 and to subsequently bond to the film once it is applied. This asymmetry can result in other structural properties, and in some cases, the number of fibers that are pushed from the nonwoven staple-fiber web 206, through the mesh material panel 210, and out of the mesh-side face 222 is larger than the number of fibers that are pushed from the mesh-side face 222, through the mesh material panel 210, and into the nonwoven staple-fiber web 206.

In some examples, the penetration depth of the web-side needles 213 is larger than the penetration depth of the mesh-side needles 215. Among other things, this can increase the likelihood that fibers arranged in the nonwoven staple-fiber web 206 will be pushed by the web-side needles 213 through the mesh material panel 210. In addition, the shorter penetration depth of the mesh-side needles 215 can decrease the likelihood that empty barbs might break or tear yarns of the mesh material panel 210. Structurally, this can result in various properties, such as deeper needle-penetration openings that extend from the web-side face 220 into the stack 214 as compared to the needle-penetration openings that extend from the mesh-side face 222 and into the stack 214. In some examples, the

In some examples, the needle-punching operations at step 204 and at step 212 can contribute to various properties associated with the substrate formed by the nonwoven staple-fiber web 206 and the mesh material panel 210. For example, as a result of the needle punching, the substrate can include fibers oriented in the z direction (e.g., based on the needles or needle barbs engaging the fibers and pushing them in the z direction). In some examples, a first set of fibers that are in the z direction might only extend through the nonwoven staple-fiber web 206 and might not extend through the mesh material panel 210, such as those fibers that are needle punched only in step 204 and that are not engaged by needles in step 212. In some examples, a second set of fibers that are in the z-direction might extend through the nonwoven staple-fiber web 206 and through the mesh material panel 210, such as those fibers that are needle punched in step 212 (and possibly also in step 204). For example, these fibers can include a first fiber segment that is positioned in the first layer of the nonwoven fiber web and a second fiber segment that is positioned in the second layer of the mesh material panel. Depending on the programming of stitch densities, the first set of fibers and the second set of fibers can have different respective quantities.

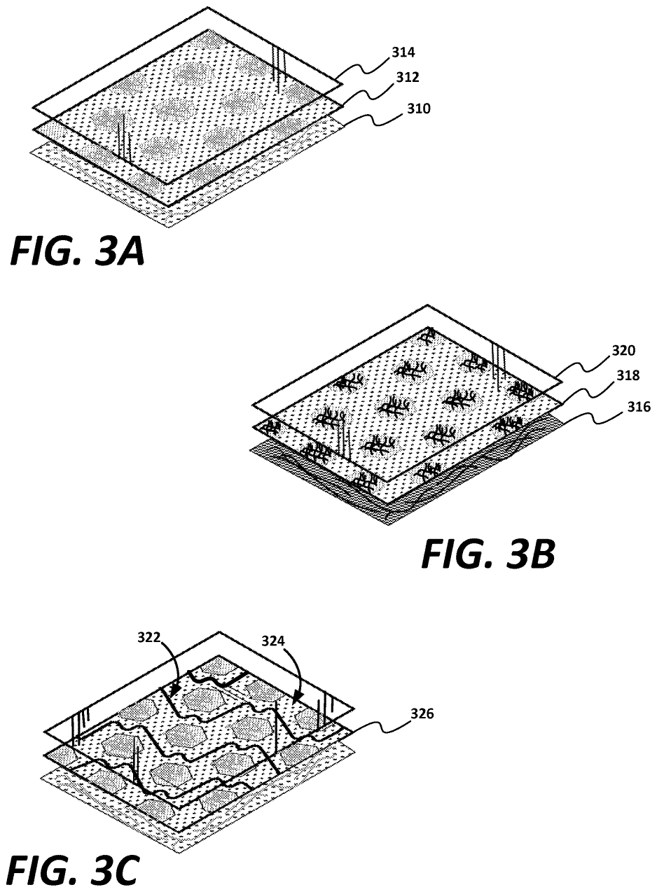

In at least some examples, the combination of the nonwoven staple-fiber web 206 and the mesh material panel 210 can form a substrate 228, which can be associated with various color properties. For example, the fibers of the nonwoven staple-fiber web 206 and the yarns of the mesh material panel 210 can have a same or similar color property, in which case the distinctness and structure of the mesh material panel 210, as well as the individual fibers, can be harder to visually detect. For example, FIG. 3A includes a web 310 and a mesh 312 with similar color properties and includes the transparent film 314.

In some examples, the same or substantially same color can be based on the fibers of the fiber web 206 being dope-dyed to include a same color as the yarns of the mesh material panel 210. In some examples, the same or substantially same color can result from the substrate being printed (e.g., sublimation printing via CO2 or some other carrier, screen printed, or some other application of dyes and/or pigments). For example, one or more colors can be imparted to the mesh material panel 210 and to the fiber web 206 after the operations of step 212. In some examples, the one or more colors can include a pattern or design that is sublimation printed onto the substrate including the mesh material panel 210 and the fiber web 206.

In some examples, the fibers of the nonwoven staple-fiber web 206 and the yarns of the mesh material panel 210 can have a different color property from one another, which can impart an interesting aesthetic to the substrate 228 by permitting the structure of the mesh material panel 210 to be visually detected (e.g., the structure of the material segment 216 and the openings 218), as well as the individual fibers extending through the material segments. For example, FIG. 3B includes the web 316 and the mesh 318 with different color properties and includes the transparent film 320.

In some examples, the different relative colors of the fiber web 316 and the mesh panel 318 can result from the fibers of the web 316 being dope-dyed to include a different color than the fibers or yarns of the mesh material panel 318.

In some examples, the different color properties of the fiber web 316 and the mesh panel 318 in FIG. 3B can result from one or more dyes or pigments added at the textile level. For example, the fiber web 316 and/or the mesh material panel 318 can be treated with a colorant, such as a dye or pigment, prior to being coupled together. In some examples, the fiber web 316 can be printed (e.g., sublimation printed, screen printed, etc.) prior to coupling with the mesh panel, and in some cases, the printing can include a design with one or more colors. In some examples, the mesh material panel 318 can be sublimation printed at the textile level prior to being coupled to the fiber web 316.

In some examples in which the mesh material panel 318 is treated with a colorant prior to coupling with the fiber web 316, the colorant can include a design with one or more colors. In such examples, the mesh material panel 318 can include a mesh configuration with a higher coverage percentage and/or a higher basis weight (e.g., the holes are smaller and/or the material portions are wider), which as compared to a mesh with a lower coverage percentage and/or lower basis weight can result in better design fidelity. For example, in examples in which a colorant is applied to the mesh material panel 318 prior to integration with the fiber web 316, the mesh material panel 318 can include a basis weight that is above 200 gsm, whereas in other examples in which the colorant is applied to the fiber web 316 alone and/or to a substrate of the fiber web 316 combined with the mesh material panel 318, the mesh material panel might include a basis weight that is between 100 gsm and 200 gsm.

In some examples the mesh material panel 210 can be constructed of a first yarn having a first color property and a second yarn having a second color property, which is different from the first color property. In addition, the fibers of the nonwoven staple-fiber web 206 can include the first color property, such that the yarn with the second color property stands out and forms an interesting pattern on the face of the substrate 228. For example, FIG. 3C includes the yarn 322 with a different color property than other parts 324 of the mesh 326. In examples, the fibers of the nonwoven staple-fiber web 206 could include the second color, similar to the second color of the second yarn, or the fibers could include a third color that is different from the first color and the second color.

Referring to FIG. 2, in examples, the substrate 228 can have various other properties. For example, the substrate 228 can include a first layer that includes the nonwoven staple-fiber web 206 and a second layer that includes the mesh material panel 210, as well as fibers from the nonwoven staple-fiber web 206. In some examples, the first layer can include, as compared to the second layer, a larger amount of silicone-infused fibers. For example, the first layer can include at least about 90% silicone-infused fibers, or at least about 95% silicone-infused fibers, whereas the second layer can include less than 50% silicone-infused fibers, or in some cases, less than 35% silicone-infused fibers. In some examples, these characteristics can also define the composite textile 202, such as after a film is applied.

In at least some examples, step 224 can include positioning a film 226 on the substrate 228, which can include the nonwoven staple-fiber web 206 coupled (e.g., via step 212) to the mesh material panel 210. The film 226 can include any of the films described with respect to the film 138.

In examples, step 230 can include applying heat and/or pressure to the film 226, such as in a press, and upon cooling and/or other curing steps, the composite textile 202 can be used for further processing (e.g., cut into a panel for an upper, printed on, extruded on, etc.). In at least some instances, based on the application of the heat and/or pressure, the film 226 (or at least a part of the film, such as the hotmelt adhesive layer) can transition to a softened, and possibly flowable, state. In addition, the film 226 (or at least the portion that has at least partially softened) can penetrate to various depths of the substrate 228. For example, the film 226 can include a first portion 232 that overlays the openings 218 and that is associated with a first penetration depth, which extends down into the nonwoven staple-fiber web 206. The first portion 232 can, in some cases, bond to the fibers in the nonwoven staple-fiber web 206, and sometimes deeper into the substrate than the mesh material panel 210, based on the film 226 flowing around and at least partially encapsulating the fibers. In addition, the film 226 can also include a second portion 234 that overlays the material segments 216 and that is associated with a second penetration depth, which might be shallower than the first penetration depth. In examples, the second portion 234 can bond to (e.g., at least partially encapsulate and mechanically bond to) both the yarns of the material segments and the fibers of the nonwoven staple-fiber web 206 that have been pushed through the material segments 216. In at least some instances a fiber of the nonwoven staple-fiber web 206 can be coupled to both the first portion 232 of the film 226 and the second portion 234 of the film 226.

In at least some examples, the depth of the penetration of the film 226 can contribute to the overall properties of the composite textile 202. For example, the penetration depth can affect the strength of the bond between the film 226 and the substrate 228. In some cases, this penetration depth can contribute to improved ply adhesion. In addition, the penetration depth of the film 226 can affect the strength and stability of the film 226.

In at least some examples, the fibers, or at least fiber ends, do not protrude beyond the outer face 236 of the film 226. For example, if a plate is used to apply heat and/or pressure, the plate can push the fibers into the film 226 to reduce the likelihood of fiber portions extending beyond the face 236. Among other things, this can provide smoother surface for aesthetics, for printing/depositing, and/or can reduce the likelihood of a protruding fiber portion snagging or pulling and affecting the structural integrity of the film 226.

In at least some examples, coupling the film 226 to the mesh material panel 210 (as well as to the nonwoven staple-fiber web 206) can reduce the likelihood of wrinkling of the film 226. For example, the mesh material panel 210 can impart structural stability to the film 226, based on the ability of the mesh material panel 210 to substantially return to an original state after removal of a force (e.g., tension or compression). In contrast, if the film 226 is coupled to a fiber web that is positioned between the film 226 and the mesh material panel 210, then the film 226 can, in some cases, be more likely to wrinkle or experience other deformations over time, based on the fiber web having a lower dimensional stability as compared to the mesh material panel 210. Without being bound by theory, wrinkling in the instance of a fiber web positioned between the mesh material panel and the film could arise from other mechanisms, such as where fibers of the fiber web might tend to cluster over time in response to repeated bending.

Although some examples do not position a discrete fiber web between the mesh material panel and the film, other examples might position a lighter-weight fiber web between the mesh material panel and the film. For example, a heavier fiber web (e.g., at least about 300 gsm) might be positioned below the mesh material panel, and a lighter fiber web (e.g., less than about 100 gsm) might be positioned between the mesh material panel and the film.

In examples, the film 226 can have various color properties. For example, in some examples, the film 226 can be at least partially transparent, in which case one or more color properties of the substrate 228 might be visually perceptible through the film 226. For example, a color of the fibers of the 206 and/or a color of the yarns of the mesh material panel 210 might be visually perceptible through the film 226. In some examples, the film 226 can include a colorant (e.g., a dye or pigment dispersed in the composition of the film), which can at least partially or completely obscure the visual perceivability of the color(s) of the substrate 228. In some examples, a texture or 3D structure can be pressed into the surface 236, such as by a release paper or other transfer sheet combined with a plate (or other tool) used to apply the heat and/or pressure (e.g., in step 230).

In some examples, one or more optional treatments or features can be applied (e.g., at step 240) to the outer face 236 of the film 226, such as a printed component 238 (e.g., screen printed, laser printed, jet printed, etc.) and/or an extruded component (e.g., 142 in FIG. 1).

In at least some examples, as an alternative to step 240 or in addition to step 240, the printed component 238 can be applied to the film 226 prior to bonding the film 226 to the needle-punched substrate. For example, the coating 140 and/or the protuberances 142 can be screen printed onto the film 226 prior to bonding the film 226 on the substrate 228.

In at least some examples, the coating 140 is applied to the film 226 by screen printing the coating 140 onto the film, and the coating 140 can have any of the properties of the print media materials described above in this disclosure. For example, the coating 140 can include an aqueous polyurethane dispersion (e.g., such as a polyether polyurethane dispersion), e.g., of the types described above for the print media material. As some more specific examples, the coating 140 may include: (a) an aqueous compact resin of polyurethane in water having a high solids content (e.g., at least 40% solids), e.g., of the types described above for the print media material; (b) a cross-linking material (e.g., a carbodiimide, an isocyanate, etc.), e.g., of the types described above for the print media material; and/or (c) a rheological modifier (e.g., a thickening agent, etc.), e.g., of the types described above for the print media material. In some examples, the coating 140 includes an amount of rheological modifier that enables the coating 140 to be screen printable. The coating 140 can, in some examples, include an alcohol (e.g., an aminoalkyl alcohol), e.g., of the types described above for the print media material. The coating 140 can, in some instances, include a debubbling agent or a defoamer, such as mineral oil.

In at least some examples, a first coating can be screen printed on the film 226, and a second coating can be screen printed on the film 226, and the first coating and the second coating can have different properties. For example, the first coating can have a different amount of silica by weight of the print media material. Screen printing parameters can vary, such a number of passes, screen size, etc. In examples, after the coating 140 (e.g., one or more coatings) is screen printed on the film 226, then film 226 can be bonded to the substrate 228.

In at least some examples, prior to bonding the film 226 to the substrate 228, the protuberances 142 can be applied to the film 226 by screen printing the protuberances 142 onto the film 226, and the protuberances 142 can have any of the properties of the print media materials described above in this disclosure. For example, the protuberances 142 can include an aqueous polyurethane dispersion (e.g., such as a polyether polyurethane dispersion), e.g., of the types described above for the print media material. As some more specific examples, the protuberances 142 may include: (a) an aqueous compact resin of polyurethane in water having a high solids content (e.g., at least 40% solids), e.g., of the types described above for the print media material; (b) a cross-linking material (e.g., a carbodiimide, an isocyanate, etc.), e.g., of the types described above for the print media material; and/or (c) a rheological modifier (e.g., a thickening agent, etc.), e.g., of the types described above for the print media material. In some examples, the protuberances 142 include an amount of rheological modifier that enables the protuberances 142 to be screen printable. The protuberances 142 can, in some examples, include an alcohol (e.g., an aminoalkyl alcohol), e.g., of the types described above for the print media material. The protuberances 142 can, in some instances, include a debubbling agent or a defoamer, such as mineral oil.

In at least some examples, the protuberances 142 are screen printed on the film 226 by applying multiple layers of the print media material to build up the z-height. For example, a first layer can be screen printed on the film 226 or on a base screen print layer that has been initially applied to the film 226 prior the first layer. The first layer can include a first viscosity and a first amount of rheological modifier (e.g., in a range of about 90,000 cps to about 110,000 cps, or about 100,000 cps). In addition, once the first layer has at least partially dried or cured, a second layer can be screen printed on top of the first layer, and the second layer can include one or more properties that are different from the first layer. For example, the second layer can include a lower viscosity (e.g., a lower amount of the rheological modifier) as compared to the first layer, and in some examples, the second layer can include a viscosity in a range of about 60,000 cps to about 80,000 cps, or in some examples about 70,000 cps.

In at least some examples, once the second layer has at least partially dried or cured, then a third layer can be screen printed on top of the second layer, and the third layer can include one or more properties that are different from the second layer and/or the first layer. For example, the third layer can include a lower viscosity (e.g., a lower amount of the rheological modifier or little to no amount of the rheological modifier) as compared to the first layer and/or the second layer, and in some examples, the third layer can include a viscosity in a range of about 4,000 cps to about 7,000 cps, or in some examples in a range between 5,000 cps and 6,000 cps.

In at least some examples, one or more additional layers can be screen printed on top of the first layer, the second layer, or the third layer.

In at least some examples, the method can include building up the z-height of the protuberances with the screen-printed layers to a size of at least 0.3 mm.

Screen printing parameters associated with the protuberances can vary, such a number of passes, screen size, etc. In examples, after the protuberances are screen printed on the film 226, then film 226 can be bonded to the substrate 228. In some examples, the protuberances are compressed to a lower z-height when the film 226 is bonded to the substrate 228 (e.g., due to the heat and/or pressure that is applied when bonding). For example, the protuberances can be compressed in a range from about 45% to about 55%, or in some examples about 50%.

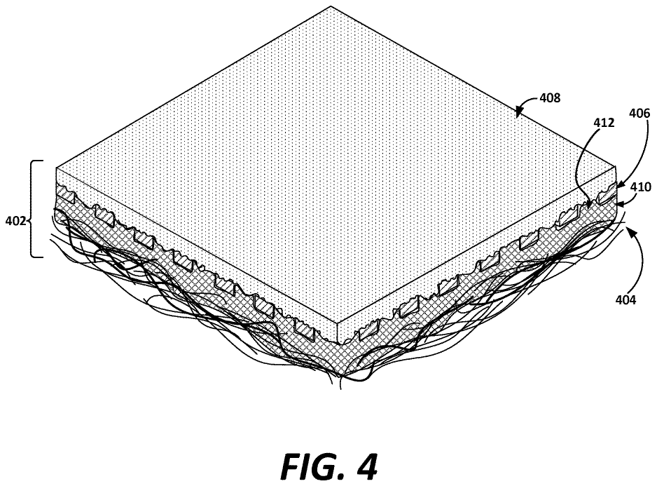

In examples of the present disclosure, a composite textile can include one or more additional or alternative layers, as compared with the composite textiles described in FIGS. 1, 2, and 3A-3C. For example, referring to FIG. 4, a composite textile 402 can include a nonwoven staple-fiber web 404, a mesh material panel 406, and a film 408. Each of these components of the composite textile 402 can include any of the elements described with respect to the corresponding one of the nonwoven staple-fiber web 134 or 206, the mesh material panel 136 or 210, and the film 138 or 226. In addition, the composite textile 402 can include any of the surface features described in this disclosure, such as 140, 142, 142a, 142b, or 238.

In at least some examples, the composite textile 402 can include an adhesive layer 410 that bonds the nonwoven staple-fiber web 404 to the mesh material panel 406. For example, the adhesive layer 410 can include a hot-melt adhesive layer, such as a thermoplastic hot-melt adhesive layer. In examples, the adhesive layer 410 can join the nonwoven staple-fiber web 404 to the mesh material panel 406 instead of the entangling the fibers of the web with the mesh, such as through fluid or needle entanglement.

The adhesive layer 410 can include one or more various types of adhesive layers. In some examples, the adhesive layer can include a thermoplastic hot-melt film. For example, the thermoplastic hot-melt film can include a thermoplastic polyurethane (TPU) hot-melt adhesive film. In some examples, the adhesive layer can include an ethylene-vinyl acetate (EVA)-based hot-melt adhesive film. In some examples, the adhesive can include a Polyether Block Amide (Pebax)-based adhesive film.

The fiber web 404 and the mesh panel 406 can be coupled via the adhesive layer 410 in various manners. In at least one example, the adhesive layer 410 can include a thermoplastic hot-melt adhesive that is layered between the fiber web 404 and the mesh panel 406. With the adhesive layer 410 positioned between the layers 404 and 406, thermal energy can be applied to transform the adhesive layer 410 to a molten or softened state. In the molten or softened state, the adhesive layer 410 can penetrate at least partially into the fibers of the fiber web 404 and can penetrate at least partially into the fibers and/or yarns of the mesh panel 406. The thermal energy can be removed to cool and resolidify the adhesive layer 410, thereby adhesively bonding to the respective layers (e.g., through mechanical interlocking).

The fiber web 404 joined to the mesh panel 406 via the adhesive layer 410 can form a substrate, and the film 408 can be applied to the substrate in a manner similar to that described with respect to FIG. 2 (e.g., operations 224 and 230 and optionally 240). In at least some examples, when the film 408 is coupled to the substrate, thermal energy might be applied to the substrate (e.g., via a tool, such as a heat press, or via the thermal energy of the film applied in a liquid or molten state). In at least some examples, this additional thermal energy can re-soften the adhesive layer 410, such as the portions 412 of the adhesive layer 410 that are positioned in the openings of the mesh panel 406. In addition, the re-softened portions 412 can bond with the film 408. For example, the re-softened portions 412 might mix with portions of the film (e.g., in a matrix-like manner where the film 408 includes a hot-melt adhesive) or otherwise bond with the film 408.

In at least some instances, using the adhesive layer 410 to join the fiber web 404 to the mesh material panel 406 instead of entanglement (e.g., through needle punching) can offer some advantages. For example, in some cases, bonding via the adhesive layer 410 can be less resource intensive as compared to entanglement. In some examples, bonding via the adhesive layer 410 can help preserve printing on the mesh panel 406 that is viewable through the film 408. That is, in some cases in which the mesh material panel 406 includes one or more colors, which can form a design, entangling the fiber web 404 with the mesh material panel 406 pushes fibers through the mesh material panel 406 and can diminish the color properties of the mesh material panel 406. As such, coupling the fiber web 404 with the mesh material panel 406 via the adhesive layer 410 can help preserve the printing, since fewer of the fiber end are protruding through the mesh material panel 406.

Various examples of composite textiles can be constructed based on the disclosure herein. Below is a table summarizing two different example composite textiles. Example 1 includes a composite textile having substrate, which includes a fiber web layer including 400 gsm of silicone-infused staple fibers, which is entangled with a mesh material panel via needle punching. The mesh material panel includes a 230 gsm tricot warp knit mesh with polyester yarns. In Example 1, a PU film (0.3 mm) is applied to the substrate on the side of the mesh material panel via a TPU hot-melt adhesive. Example 1 could be constructed via one or more of the steps associated with FIG. 2. In Example 2, the composite textile includes a substrate, which includes a fiber web layer including 400 gsm of silicone-infused staple fibers that is bonded to a mesh material panel via a hot-melt adhesive. In Example 2, the hot-melt adhesive includes a TPU hot-melt and the mesh material panel includes a 230 gsm tricot warp knit mesh with polyester yarns. In addition, a PU film is applied to the substrate on the side of the mesh material panel via a TPU hotmelt adhesive.

| | | Elongation | Residual | | | | |
|---|---|---|---|---|---|---|---|
| | | % (CD/MD) | Elongation | Elongation | Elongation | Elongation | Tensile |
| | Stiffness | @ | % | % @ 50N | % @ 100N | % @ 150 N | Strength |
| | (N/mm) | 100 cycles | (CD/MD) | (CD/MD) | (CD/MD) | (CD/MD) | (CD/MD) |
| 1 | 6.86 | 19.9/15.7 | 7.46/5.79 | 1.60/1.37 | 3.20/2.65 | 5.35/4.35 | 875N/525N |
| 2 | 5.92 | 21.8/15.0 | 7.80/5.13 | 3.89/2.49 | 7.69/4.29 | 12.10/6.59 | 900N/875N |

In the above table, stiffness can be measured using ASTMD4032 (2008), which can be used to calculate the N/mm. In addition, the elongation % at 100 cycles can be determined under a force of 200N. For example, three samples in both the MD and CD can be cut with each sample measuring about 2.54 cm×15.24 cm. Each specimen can be stretched to 2.5 N at a rate of 10 mm/min. Then, the gauge (length 100 mm) can be reset and specimens can be fatigued for 100 cycles to a 200 N load at a rate of 300 mm/min. Finally, the specimen can be stretched to 2.5 N at a rate of 10 mm/min.

Although Example 1 shows better stability and resistance to stretch under 200N of force, Example 2 includes slightly better softness (less stiff) and similar total elongation after repeated cycles and similar residual elongation. In some use cases, Example 1 may be preferred, such as where less stretch is desired, especially when subjected to lower forces, including use cases (e.g., football/soccer, American football, basketball, etc.) in which the upper might be subjected to higher lateral forces (e.g., when the wearer is cutting, accelerating, quickly starting/stopping, etc.). Example 2 might be preferred when lower stretch is less of a priority and/or where increased softness is more important, such as more casual-use footwear articles or footwear articles for athletes that might exert lower forces (e.g., younger athletes).

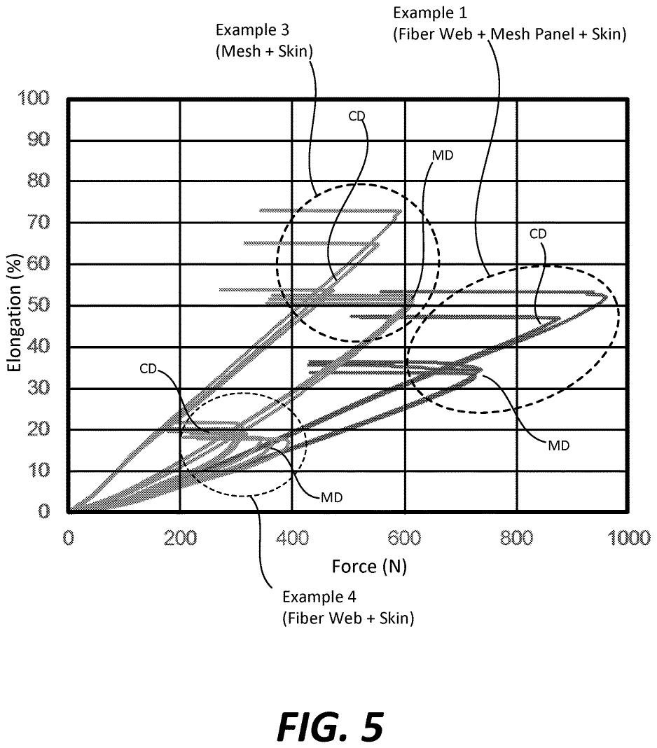

Referring to FIG. 5, a chart illustrates elongation data related to three different composite textiles. A first textile includes Example 1, as described with respect to the table above, including a fiber web layer including 400 gsm of silicone-infused staple fibers, which is entangled with a mesh material panel (230 gsm tricot warp knit mesh with polyester yarns) via needle punching, to which a PU film is applied via hot-melt adhesive. Example 3 includes a mesh material panel, which includes 230 gsm tricot warp knit mesh with polyester yarns, and a PU film that is attached via a hot-melt adhesive. Example 4 includes a fiber web layer including 400 gsm of silicone-infused staple fibers, to which a PU film is coupled via hot-melt adhesive.

As shown in FIG. 5, the combination of the fiber web with mesh panel and PU film demonstrates lower stretch and elongation at equivalent forces and also demonstrates a higher tensile strength, which indicates Example 1 can impart various advantages, especially in use cases in which the wearer imparts higher forces on the upper.

In order to test the properties shown in FIG. 5, three samples in both the MD and CD can be cut with each sample measuring about 2.54 cm×15.24 cm. Tensile strength (kgf/2.54 cm) and elongation (%) can be measured for each sample with a 100 mm gauge length at a rate of 300 mm/min.

### EXAMPLE CLAUSES

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Clause 1. A footwear article comprising: an upper that is coupled to a sole and that comprises a composite textile; the composite textile comprising: a first layer comprising a nonwoven staple-fiber web, which comprises first fibers, wherein the first fibers comprise a solid dispersion comprising at least one synthetic polymer and a silicone polymer; a second layer that is positioned adjacent the first layer and that comprises a material panel having a first side oriented towards the first layer and a second side oriented away from the first layer, wherein the material panel comprises a network of interconnected material segments and a plurality of openings; and wherein the first fibers include at least some first fiber segments positioned in the first layer and at least some second fiber segments that extend from the first layer and entirely through a material segment of the interconnected material segments; and a third layer comprising a polymeric film, wherein the second layer is positioned between the third layer and the first layer; and wherein the polymeric film comprises a first portion that overlays the material segment and that is coupled to the second side of the material panel, to the second fiber segments, or to both the second side of the material panel and to the second fiber segments.

Clause 2. The footwear article of clause 1, wherein the material panel comprises a knit material panel, a woven material panel, or a braided material panel.

Clause 3. The footwear article of clause 2, wherein the material segment comprises a first yarn strand coupled with a second yarn strand.

Clause 4. The footwear article of clause 3, wherein the second fiber segments extend between the first yarn strand and the second yarn strand when extending through the material segment, or alternatively, wherein the second fiber segments extend through a loop of a knit stitch formed by the first yarn strand.

Clause 5. The footwear article of clause 3, wherein the first yarn strand comprises a first color and the second yarn strand comprises a second color, which is different from the first color.

Clause 6. The footwear article of clause 5, wherein the second fiber segments comprise the first color.

Clause 7. The footwear article of clause 5, wherein the polymer film is at least partially transparent.

Clause 8. The footwear article of clause 1, wherein fibers of the first fibers comprise 0.1 to 20 weight percent of silicone.

Clause 9. The footwear article of clause 8, wherein the fibers comprise 0.5 to 3 weight percent of silicone.

Clause 10. The footwear article of clause 8, where the at least one synthetic polymer comprises a polyester.

Clause 11. The footwear article of clause 1, wherein the polymeric film comprises a second portion that overlays an opening of the plurality of openings and that is directly coupled to the first fiber segments.

Clause 12. The footwear article of clause 11, wherein the first portion penetrates a first depth into the material segment; wherein the second portion penetrates a second depth into the nonwoven staple-fiber web; and wherein the second depth is larger than the first depth.

Clause 13. The footwear article of clause 1, wherein the nonwoven staple-fiber web comprises a heavier basis weight than the material panel, or alternatively, wherein the nonwoven staple-fiber web is thicker than the material panel, or alternatively, wherein the nonwoven staple-fiber web comprises, as compared to the material panel, different stretch recovery, different elongation, and/or different tear strength.

Any of clauses 1 through 13, wherein a print media material is on at least a portion of a surface of the polymer film, wherein the print media material comprises, as compared to the surface of the polymer film, a different coefficient of friction; and optionally wherein the print media material comprises an aqueous polyurethane dispersion; and optionally wherein the print media material comprises silica; and optionally wherein the print media material comprises 4% or less by weight of the silica; and optionally wherein a first portion of the print media is positioned in a first area of the upper, wherein the upper further comprises a second portion of the print media material positioned in a second area that is different than the first area, and wherein the second portion comprises one or more different properties than the first portion; and optionally wherein the print media material comprises a rheological modifier; and optionally wherein the print media material comprises 1% or less by weight of the rheological modifier; and optionally wherein the print media material comprises a crosslinker; and optionally wherein the print media material comprises 4% or less by weight of the crosslinker; and optionally wherein the print media material comprises a debubbling agent; and optionally wherein the print media material comprises mineral oil; and optionally wherein the print media material comprises a coating; and optionally wherein the print media material comprises a protuberance; and optionally wherein the protuberance comprises a first layer comprising a first amount of a rheological modifier by weight of the print media material and a second layer comprising a second amount of the rheological modifier by weight of the print media material, and wherein the first amount is different than the second amount; and optionally wherein the first layer is between the second layer and the polymeric film and the first amount is higher than the second amount.

Clause 14. A footwear article comprising: an upper that is coupled to a sole and that comprises a composite textile; the composite textile comprising: a first layer comprising a nonwoven staple-fiber web, which comprises first fibers; a second layer that is positioned adjacent the first layer and that comprises a mesh material panel having a first side oriented towards the first layer and a second side oriented away from the first layer, wherein the mesh material panel comprises a network of interconnected material segments and a plurality of openings; and wherein the first fibers include at least some first fiber segments positioned in the first layer and at least some second fiber segments that extend from the first layer and entirely through a material segment of the interconnected material segments; and a third layer comprising a polymeric film, wherein the second layer is positioned between the third layer and the first layer; and wherein at least a portion of the third layer is coupled to the material segment and to the second fiber segments that extend entirely through the material segment.

Clause 15. The footwear article of clause 14, wherein the mesh material panel comprises a knit material panel, a woven material panel, or a braided material panel.

Clause 16. The footwear article of clause 15, wherein the material segment comprises a first yarn strand coupled to a second yarn strand.

Clause 17. The footwear article of clause 16, wherein the second fiber segments extend between the first yarn strand and the second yarn strand when extending through the material segment, or alternatively, wherein the second fiber segments extend through a loop of a knit stitch formed by the first yarn strand.

Clause 18. The footwear article of clause 16, wherein the first yarn strand comprises a first color and the second yarn strand comprises a second color, which is different from the first color.

Clause 19. The footwear article of clause 18, wherein the second fiber segments comprise the first color.

Clause 20. The footwear article of clause 18, wherein the polymeric film is at least partially transparent.

Clause 21. The footwear article of clause 14, wherein the first fibers comprise silicone.

Clause 22. The footwear article of clause 21, wherein the first fibers comprise a solid dispersion comprising at least one synthetic polymer and a silicone polymer.

Clause 23. The footwear article of clause 22, wherein the at least one synthetic polymer comprises a polyester.

Clause 24. The footwear article of clause 23, wherein the first fibers comprise 0.1 to 20 weight percent of silicone.

Clause 25. The footwear article of clause 24, wherein the third layer comprises a second portion that is coupled to the first fiber segments.

Clause 26. The footwear article of clause 14, wherein the nonwoven staple-fiber web comprises a heavier basis weight than the mesh material panel, or alternatively, wherein the nonwoven staple-fiber web is thicker than the material panel, or alternatively, wherein the nonwoven staple-fiber web comprises, as compared to the material panel, different stretch recovery, different elongation, and/or different tear strength.

Clause 27. A footwear article comprising: an upper that is coupled to a sole and that comprises a composite textile; and the composite textile comprising: a first layer comprising a nonwoven staple-fiber web, which comprises at least 95% by weight of silicone-infused fibers; and a second layer that is positioned adjacent the first layer and that comprises a first side oriented towards the first layer and a second side oriented away from the first layer, wherein the second layer comprises a material panel comprising a network of interconnected material segments and a plurality of openings; wherein at least some of the silicone-infused fibers extend from the first layer and into the second layer; and wherein the second layer comprises less than 50% by weight of silicone-infused fibers.

Clause 28. The footwear article of clause 27, wherein the material panel comprises a knit material panel, a woven material panel, or a braided material panel.

Clause 29. The footwear article of clause 28, wherein the material segment comprises a first yarn strand coupled to a second yarn strand.

Clause 30. The footwear article of clause 29, wherein the at least some of the silicone-infused fibers extending into the second layer extend between the first yarn strand and the second yarn strand, or alternatively, through a loop of a knit stitch formed by the first yarn strand.

Clause 31. The footwear article of clause 27 further comprising, a third layer comprising a polymeric film, wherein the second layer is positioned between the third layer and the first layer.

Clause 32. The footwear article of clause 31, wherein the polymeric film is bonded to at least some of the silicone-infused fibers that extend into the second layer.

Clause 33. The footwear article of clause 27, wherein the silicone-infused fibers comprise 0.1 to 20 weight percent of silicone.

Clause 34. The footwear article of clause 33, wherein the silicone-infused fibers comprise a solid dispersion comprising at least one synthetic polymer and the silicone, and wherein the silicone comprises a form of dispersed, compacted inclusions, which are substantially homogeneously distributed in the solid dispersion.

Clause 35. The footwear article of clause 34, wherein the at least one synthetic polymer comprises a polyester.

Clause 36. The footwear article of clause 27, wherein the nonwoven staple-fiber web comprises a heavier basis weight than the material panel, or alternatively, wherein the nonwoven staple-fiber web is thicker than the material panel, or alternatively, wherein the nonwoven staple-fiber web comprises, as compared to the material panel, different stretch recovery, different elongation, and/or different tear strength.

Clause 37. A footwear article comprising: an upper that is coupled to a sole and that comprises a composite textile; the composite textile comprising: a first layer comprising a nonwoven staple-fiber web, which comprises first fibers, wherein the first fibers comprise a solid dispersion comprising at least one synthetic polymer and a silicone polymer; and wherein the nonwoven staple-fiber web comprises a first basis weight of at least 350 gsm; a second layer that is positioned adjacent the first layer and that comprises a mesh material panel having a first side oriented towards the first layer and a second side oriented away from the first layer, wherein the mesh material panel comprises a knit textile that comprises a second basis weight of at least 200 gsm; and a third layer comprising a polymeric film, wherein the second layer is positioned between the third layer and the first layer, and wherein the third layer comprises a hotmelt adhesive that extends into at least a portion of the mesh material panel and into at least a portion of the nonwoven staple-fiber web.

Clause 38. The footwear article of clause 37, wherein the first basis weight is about 400 gsm.

Clause 39. The footwear article of clause 37, wherein the knit textile comprises a warp-knit mesh.

Clause 40. The footwear article of clause 39, wherein the warp-knit mesh comprises a plurality of yarn strands that are thermoset.

Clause 41. The footwear article of clause 37, wherein the at least one synthetic polymer comprises polyester.

Clause 42. The footwear article of clause 37, wherein fibers of the first fibers comprise 0.1 to 20 weight percent of silicone.

Clause 43. A footwear article comprising: an upper that is coupled to a sole and that comprises a composite textile; the composite textile comprising: a first layer comprising a nonwoven staple-fiber web, which comprises first fibers; a second layer that is positioned adjacent the first layer and that comprises a mesh material panel having a first side oriented towards the first layer and a second side oriented away from the first layer; a third layer comprising a film, wherein the second layer is positioned between the third layer and the first layer and wherein the film comprises a first coefficient of friction; and a coating on at least a portion of the film, wherein the coating comprises a second coefficient of friction that is different from the first coefficient of friction.

Clause 44. The footwear article of clause 43, wherein the coating comprises a print media material.

Clause 45. The footwear article of clause 44, wherein the print media material comprises an aqueous polyurethane dispersion.

Clause 46. The footwear article of clause 44 or clause 45, wherein the print media material comprises silica.

Clause 47. The footwear article of clause 46, wherein the print media material comprises 4% or less by weight of the silica.

Clause 48. The footwear article of any of clauses 43 to 47, wherein the coating comprises a first coating positioned in a first area of the upper, wherein the upper further comprises a second coating positioned in a second area that is different than the first area, and wherein the second coating comprises one or more different properties than the first coating.

Clause 49. The footwear article of any of clauses 44 to 48, wherein the print media material comprises a rheological modifier.

Clause 50. The footwear article of clause 49, wherein the print media material comprises 1% or less by weight of the rheological modifier.

Clause 51. The footwear article of any of clauses 44 to 50, wherein the print media material comprises a crosslinker.

Clause 52. The footwear article of clause 51, wherein the print media material comprises 4% or less by weight of the crosslinker.

Clause 53. A footwear article comprising: an upper that is coupled to a sole and that comprises a composite textile; the composite textile comprising: a first layer comprising a nonwoven staple-fiber web, which comprises first fibers; a second layer that is positioned adjacent the first layer and that comprises a mesh material panel having a first side oriented towards the first layer and a second side oriented away from the first layer; a third layer comprising a film, wherein the second layer is positioned between the third layer and the first layer and wherein the film comprises a first coefficient of friction; and one or more protuberances on at least a portion of the film, wherein the one or more protuberances comprise a second coefficient of friction that is different from the first coefficient of friction.

Clause 54. The footwear article of clause 53, wherein one or more protuberances comprise a print media material.

Clause 55. The footwear article of clause 54, wherein the print media material comprises an aqueous polyurethane dispersion.

Clause 56. The footwear article of clause 54 or clause 55, wherein the print media material comprises a rheological modifier.

Clause 57. The footwear article of clause 56, wherein the protuberance comprises a first layer comprising a first amount of the rheological modifier by weight of the print media material and a second layer comprising a second amount of the rheological modifier by weight of the print media material, and wherein the first amount is different than the second amount.

Clause 58. The footwear article of clause 57, wherein the first layer is between the second layer and the film and the first amount is higher than the second amount.

Clause 59. The footwear article of clause 57 or clause 58, wherein the first layer comprises a first amount of a pigment by weight of the print media material, and wherein the second layer comprises a second amount of the pigment by weight of the print media material.

Clause 60. The footwear article of clause 59, wherein the second layer is a clear topcoat.

Clause 61. The footwear article of any of clauses 54 to 60, wherein the print media material comprises a crosslinker.

Clause 62. The footwear article of clause 61, wherein the print media material comprises 4% or less by weight of the crosslinker.

Clause 63. The footwear article of any of clauses 54 to 62, wherein the print media material comprises a debubbling agent.

Clause 64. The footwear article of clause 63, wherein the print media material comprises mineral oil.

Clause 65. A method of making an upper for a footwear article, the method comprising: constructing a substrate by coupling a nonwoven fiber web with a material panel; screen printing a print media material onto a film; and bonding the film with the print media material to the substrate.

Clause 66a. The method of clause 65, wherein the material panel comprises a mesh material panel.

Clause 66b. The method of clause 65 or clause 66a, wherein the print media material comprises a print media material.

Clause 67. The method of clause 66b, wherein the print media material comprises an aqueous polyurethane dispersion.

Clause 68. The method of clause 66b or clause 67, wherein the print media material comprises a rheological modifier.

Clause 69. The method of any of clauses 66b to 68, wherein the print media material comprises silica.

Clause 70. The method of any of clauses 65 to 68, wherein screen printing the print media material comprises screen printing a first layer and screen printing a second layer at least partially on the first layer, and wherein the second layer comprises one or more properties that are different from the first layer.

Clause 71. The method of clause 70, wherein the one or more properties comprise a viscosity.

Clause 72. The method of clause 71, wherein the first layer comprises a first viscosity and the second layer comprises a second viscosity, which is lower than the first viscosity.

Clause 73. The method of any of clauses 65 to 72, wherein screen printing the print media material comprises forming a protuberance having a first z-height, and wherein bonding the film to the substrate comprises applying one or more of heat and pressure to the protuberance and compressing the protuberance to a second z-height, which is less than the first z-height.

Clause 74. The method of any of clauses 65 to 73, wherein coupling the nonwoven fiber web with the mesh material panel comprises needle entangling fibers of the nonwoven fiber web with the mesh material panel.

Clause 75. The method of any of clauses 65 to 73, wherein coupling the nonwoven fiber web with the mesh material panel comprises bonding fibers of the nonwoven fiber web to the mesh material panel by a hot-melt adhesive positioned between the nonwoven fiber web and the mesh material panel.

Clause 76. A footwear article comprising: an upper that is coupled to a sole and that comprises a composite textile; the composite textile comprising: a first layer comprising a nonwoven layer, which comprises first fibers, wherein the first fibers comprise a solid dispersion comprising at least one synthetic polymer and a silicone polymer; a second layer that is positioned adjacent the first layer and that comprises a material panel having a first side oriented towards the first layer and a second side oriented away from the first layer; and wherein the first fibers include at least some first fiber segments positioned in the first layer and at least some second fiber segments that extend from the first layer and entirely through the material panel; and a third layer comprising a polymeric film, wherein the second layer is positioned between the third layer and the first layer; and wherein the polymeric film is coupled to the second side of the material panel, to the second fiber segments, or to both the second side of the material panel and the second fiber segments.

Clause 77. The footwear article of Clause 76, wherein the nonwoven layer comprises a staple-fiber web, and optionally, wherein the second layer comprises a network of interconnected material segments and a plurality of openings.

Clause 78. A footwear article comprising: an upper that is coupled to a sole and that comprises a composite textile; and the composite textile comprising: a first layer comprising a nonwoven layer comprising first fibers; a second layer that is positioned adjacent the first layer and that comprises a mesh material panel having a first side oriented towards the first layer and a second side oriented away from the first layer; wherein the mesh material panel comprises a network of interconnected material segments and a plurality of through-openings; and a third layer comprising a polymeric film, wherein the second layer is positioned between the third layer and the first layer; wherein the polymeric film comprises a first portion that overlays a material segment of the network of interconnected material segments and a second portion that overlays a through-opening of the plurality of through-openings; wherein the first portion penetrates a first depth into the material segment and the second portion penetrates a second depth through the through-opening and into the nonwoven layer; and wherein the second depth is larger than the first depth.

Clause 79. A footwear article comprising: an upper that is coupled to a sole and that comprises a composite textile; and the composite textile comprising: a first layer comprising a nonwoven layer comprising first fibers; a second layer that is coupled to the first layer and that comprises a mesh material panel having a first side oriented towards the first layer and a second side oriented away from the first layer; wherein the mesh material panel comprises a network of interconnected material segments and a plurality of through-openings; and a third layer comprising a polymeric film, wherein the second layer is positioned between the third layer and the first layer.

Clause 80. The footwear article of Clause 79, wherein the second layer is coupled to the first layer by an adhesive layer positioned between the first layer and the second layer.

Clause 81. The footwear article of Clause 80, wherein the adhesive layer comprises a first thermoplastic hot-melt adhesive layer.

Clause 82. The footwear article of Clause 81, wherein the polymer film is coupled to the second side of the second layer by a second thermoplastic hot-melt adhesive layer.

Clause 83. The footwear article of Clause 82, wherein in a through-opening of the plurality of through-openings, a portion of the first thermoplastic hot-melt adhesive layer is intermixed with a portion of the second thermoplastic hot-melt adhesive layer.

Clause 84. The footwear article of any of Clauses 80 to 83, wherein the mesh material panel comprises a plurality of sublimation printed dyes comprising a plurality of colors.

Clause 85. The footwear article of Clause 84, wherein the mesh material panel comprises a basis weight that is greater than 200 gsm.

Example Clause A: A footwear article may include: an upper that is coupled to a sole and that may include a composite textile; the composite textile may include: a first layer may include a nonwoven staple-fiber web, which may include first fibers; a second layer that is positioned adjacent the first layer and that may include a material panel having a first side oriented towards the first layer and a second side oriented away from the first layer, where the material panel may include a network of interconnected material segments and a plurality of openings; and where the first fibers include at least some first fiber segments positioned in the first layer and at least some second fiber segments that extend from the first layer and entirely through a material segment of the interconnected material segments; and a third layer may include a polymeric film, where the second layer is positioned between the third layer and the first layer; and where the polymeric film may include a first portion that overlays the material segment and is coupled to the second fiber segments that extend entirely through the material segment.

Example Clause B: The footwear article of Example Clause A, where the mesh material panel may include a knit material panel, a woven material panel, or a braided material panel.

Example Clause C: The footwear article of Example Clause A or Example Clause B, where the material segment may include a first yarn strand coupled with a second yarn strand.

Example Clause D: The footwear article of any one of Example Clauses A-C, where the second fiber segments extend between the first yarn strand and the second yarn strand when extending through the material segment, or alternatively, where the second fiber segments extend through a loop of a knit stitch formed by the first yarn strand.

Example Clause E: The footwear article of any one of Example Clauses A-D, where the first yarn strand may include a first color and the second yarn strand may include a second color, which is different from the first color.

Example Clause F: The footwear article of any one of Example Clauses A-E, where the second fiber segments may include the first color.

Example Clause G: The footwear article of any one of Example Clauses A-F, where the polymer film is at least partially transparent.

Example Clause H: The footwear article of any one of Example Clauses A-G, where the first fibers may include silicone.

Example Clause I: The footwear article of any one of Example Clauses A-H, where the first fibers may include a solid dispersion may include at least one synthetic polymer and a silicone polymer.

Example Clause J: The footwear article of any one of Example Clauses A-I, where the at least one synthetic polymer may include a polyester.

Example Clause K: The footwear article of any one of Example Clauses A-J, where the polymeric film may include a second portion that overlays an opening of the plurality of openings and that is directly coupled to the first fiber segments.

Example Clause L: The footwear article of any one of Example Clauses A-K, where the first portion penetrates a first depth into the material segment; where the second portion penetrates a second depth into the nonwoven staple-fiber web; and where the second depth is larger than the first depth.

Example Clause M: The footwear article of any one of Example Clauses A-L, where the nonwoven staple-fiber web may include a heavier basis weight than the mesh material panel, or alternatively, where the nonwoven staple-fiber web is thicker than the mesh material panel, or alternatively, where the nonwoven staple-fiber web may include, as compared to the mesh material panel, different stretch recovery, different elongation, and/or different tear strength.

Example Clause N: A footwear article may include: an upper that is coupled to a sole and that may include a composite textile; the composite textile may include: a first layer may include a nonwoven staple-fiber web, which may include first fibers; a second layer that is positioned adjacent the first layer and that may include a mesh material panel having a first side oriented towards the first layer and a second side oriented away from the first layer, where the mesh material panel may include a network of interconnected material segments and a plurality of openings; and where the first fibers include at least some first fiber segments positioned in the first layer and at least some second fiber segments that extend from the first layer and entirely through a material segment of the interconnected material segments; and a third layer may include a polymeric film, where the second layer is positioned between the third layer and the first layer; and where a first portion of the third layer is coupled to the material segment.

Example Clause O: The footwear article of Example Clause N, where the mesh material panel may include a knit material panel, a woven material panel, or a braided material panel.

Example Clause P: The footwear article of Example Clause N or Example Clause O, where the material segment may include a first yarn strand coupled to a second yarn strand.

Example Clause Q: The footwear article of any one of Example Clauses N-P, where the second fiber segments extend between the first yarn strand and the second yarn strand when extending through the material segment, or alternatively, where the second fiber segments extend through a loop of a knit stitch formed by the first yarn strand.

Example Clause R: The footwear article of any one of Example Clauses N-Q, where the first yarn strand may include a first color and the second yarn strand may include a second color, which is different from the first color.

Example Clause S: The footwear article of any one of Example Clauses N-R, where the second fiber segments may include the first color.

Example Clause T: The footwear article of any one of Example Clauses N-S, where the polymer film is at least partially transparent.

Example Clause U: The footwear article of any one of Example Clauses N-T, where the first fibers may include silicone.

Example Clause V: The footwear article of any one of Example Clauses N-U, where the first fibers may include a solid dispersion may include at least one synthetic polymer and a silicone polymer.

Example Clause W: The footwear article of any one of Example Clauses N-V, where the at least one synthetic polymer may include a polyester.

Example Clause X: The footwear article of any one of Example Clauses N-W, where the first portion is coupled to the second fiber segments extending entirely through the material segment.

Example Clause Y: The footwear article of any one of Example Clauses N-X, where the third layer may include a second portion that is coupled to the first fiber segments.

Example Clause Z: The footwear article of any one of Example Clauses N-Y, where the nonwoven staple-fiber web may include a heavier basis weight than the mesh material panel.

Example Clause AA: A footwear article may include: an upper that is coupled to a sole and that may include a composite textile; the composite textile may include: a first layer may include a nonwoven staple-fiber web, which may include first fibers; a second layer that is positioned adjacent the first layer and that may include a mesh material panel having a first side oriented towards the first layer and a second side oriented away from the first layer, where the mesh material panel may include a network of interconnected material segments and a plurality of openings; and a third layer may include a polymeric film, where the second layer is positioned between the third layer and the first layer; where the polymeric film may include a first portion that overlays a material segment of the network of interconnected material segments and that penetrates a first depth into the material segment; where the polymeric film may include a second portion that overlays an opening of the plurality of openings and that penetrates a second depth into the nonwoven staple-fiber web; and where the second depth is larger than the first depth.

Example Clause AB: The footwear article of Example Clause AA, where the mesh material panel may include a knit material panel, a woven material panel, or a braided material panel.

Example Clause AC: The footwear article of Example Clause AA or Example Clause AB, where the material segment may include a first yarn strand coupled to a second yarn strand.

Example Clause AD: The footwear article of any one of Example Clauses AA-AC, where the mesh material panel may include a warp-knit mesh, and where the first yarn strand may include knit stitches that are interlooped with the second yarn strand.

Example Clause AE: The footwear article of any one of Example Clauses AA-AD, where the first yarn strand may include a first color and the second yarn strand may include a second color, which is different from the first color.

Example Clause AF: The footwear article of any one of Example Clauses AA-AE, where the polymer film is at least partially transparent.

Example Clause AG: The footwear article of any one of Example Clauses AA-AF, where the first fibers may include silicone.

Example Clause AH: The footwear article of any one of Example Clauses AA-AG, where the first fibers may include, at room temperature, a solid dispersion may include at least one synthetic polymer and a silicone polymer.

Example Clause AI: The footwear article of any one of Example Clauses AA-AH, where the at least one synthetic polymer may include a polyester.

Example Clause AJ: The footwear article of any one of Example Clauses AA-AI, where the nonwoven staple-fiber web may include a heavier basis weight than the mesh material panel.

Example Clause AK: A footwear article may include: an upper that is coupled to a sole and that may include a composite textile; the composite textile may include: a first layer may include a nonwoven staple-fiber web, which may include first fibers, where the first fibers may include a solid dispersion may include at least one synthetic polymer and a silicone polymer; a second layer that is positioned adjacent the first layer and that may include a mesh material panel having a first side oriented towards the first layer and a second side oriented away from the first layer, where the mesh material panel may include a network of interconnected material segments and a plurality of openings, and where the first fibers include at least some first fiber segments positioned in the first layer and at least some second fiber segments that extend from the first layer and entirely through a material segment of the interconnected material segments; and a third layer may include a polymeric film, where the second layer is positioned between the third layer and the first layer; and where the polymeric film is coupled to the material segment, to the second fiber segments, or to a combination thereof.

Example Clause AL: The footwear article of Example Clause AK, where the first fibers may include a denier in a range of about 1 D to about 3D.

Example Clause AM: The footwear article of Example Clause AK or Example Clause AL, where the denier is about 1.5 D.

Example Clause AN: The footwear article of any one of Example Clauses AK-AM, where the at least one synthetic polymer may include a polyester.

Example Clause AO: The footwear article of any one of Example Clauses AK-AN, where fiber of the first fibers may include an outer surface that may include the at least one synthetic polymer and where the polymer film is coupled to the outer surface.

Example Clause AP: A footwear article may include: an upper that is coupled to a sole and that may include a composite textile; the composite textile may include: a first layer may include a nonwoven layer, which may include first fibers, where the first fibers may optionally include a solid dispersion that may include at least one synthetic polymer and a silicone polymer; and where the nonwoven layer may include a first basis weight of at least 350 gsm; a second layer that is positioned adjacent the first layer and that may include a mesh material panel having a first side oriented towards the first layer and a second side oriented away from the first layer, where the mesh material panel may include a knit textile that may include a second basis weight of at least 200 gsm; and a third layer may include a polymeric film, where the second layer is positioned between the third layer and the first layer, and where the third layer may include a hotmelt adhesive that penetrates into at least a portion of the mesh material panel and into at least a portion of the nonwoven staple-fiber web.

Example Clause AQ: The footwear article of Example Clause AP, where the first basis weight is about 400 gsm.

Example Clause AR: The footwear article of Example Clause AP or Example Clause AQ, where the knit textile may include a warp-knit mesh.

Example Clause AS: The footwear article of any one of Example Clauses AP-AR, where the warp-knit mesh may include a plurality of yarn strands that are thermoset.

Example Clause AT: The footwear article of any one of Example Clauses AP-AS, where the at least one synthetic polymer may include polyester.

Example Clause AU: A footwear article may include: an upper that is coupled to a sole and that may include a composite textile; and the composite textile may include: a first layer may include a nonwoven layer, which may include at least 95% by weight of silicone-infused fibers; and a second layer that is positioned adjacent the first layer and that may include a first side oriented towards the first layer and a second side oriented away from the first layer, where at least some of the silicone-infused fibers extend from the first layer and into the second layer; and where the second layer may include less than 50% by weight of silicone-infused fibers.

Example Clause AV: The footwear article of Example Clause AU further may include, a third layer may include a polymeric film, where the second layer is positioned between the third layer and the first layer.

Example Clause AW: The footwear article of Example Clause AU or Example Clause AV, where the second layer may include less than 30% by weight of silicone-infused fibers.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

Claimed is:

1. A footwear article comprising:
an upper that is coupled to a sole and that comprises a composite textile; and
the composite textile comprising:
a first layer comprising a nonwoven staple-fiber web, which comprises first fibers, wherein the first fibers comprise a solid dispersion comprising at least one synthetic polymer and a silicone polymer;
a second layer that is positioned adjacent the first layer and that comprises a material panel having a first side oriented towards the first layer and a second side oriented away from the first layer, wherein the first fibers include at least some first fiber segments positioned in the first layer and at least some second fiber segments that extend from the first layer and entirely through the material panel; and
a third layer comprising a polymeric film, wherein the second layer is positioned between the third layer and the first layer; and wherein the polymeric film is coupled to the second side of the material panel, to the second fiber segments, or to both the second side of the material panel and to the second fiber segments.

2. The footwear article of claim 1, wherein the material panel comprises a knit material panel, a woven material panel, or a braided material panel.

3. The footwear article of claim 2, wherein the material panel comprises a first yarn strand coupled with a second yarn strand.

4. The footwear article of claim 3, wherein the second fiber segments extend between the first yarn strand and the second yarn strand when extending through the material panel, or alternatively, wherein the second fiber segments extend through a loop of a knit stitch formed by the first yarn strand.

5. The footwear article of claim 3, wherein the first yarn strand comprises a first color and the second yarn strand comprises a second color, which is different from the first color.

6. The footwear article of claim 5, wherein the second fiber segments comprise the first color.

7. The footwear article of claim 1, wherein the material panel comprises a knit mesh textile comprising a network of interconnected knitted material segments and a pattern of integrally-knitted through openings arranged in a repeating pattern.

8. The footwear article of claim 7, wherein the polymeric film comprises a first portion that overlays a knitted material segment of the network of interconnected material segments and a second portion that overlays an integrally-knitted through opening of the pattern of integrally-knitted through openings and that is directly coupled to the first fiber segments.

9. The footwear article of claim 8, wherein the first portion penetrates a first depth into the material segment; wherein the second portion penetrates a second depth into the nonwoven staple-fiber web; and wherein the second depth is larger than the first depth.

10. The footwear article of claim 1, wherein the silicone polymer comprises dispersed, compacted inclusions, which are substantially homogeneously distributed in the solid dispersion.

11. The footwear article of claim 1 further comprising, a print media material on at least a portion of a surface of the polymer film, wherein the print media material comprises, as compared to the surface of the polymer film, a different coefficient of friction.

12. The footwear article of claim 11, wherein the print media material comprises an aqueous polyurethane dispersion.

13. The footwear article of claim 11, wherein a first portion of the print media is positioned in a first area of the upper, wherein the upper further comprises a second portion of the print media material positioned in a second area that is different than the first area, and wherein the second portion comprises one or more different properties than the first portion.

14. The footwear article of claim 11, wherein the print media material comprises a coating.

15. The footwear article of claim 11, wherein the print media material comprises a protuberance.

16. The footwear article of claim 15, wherein the protuberance comprises a first layer comprising a first amount of a rheological modifier by weight of the print media material and a second layer comprising a second amount of the rheological modifier by weight of the print media material, and wherein the first amount is different than the second amount.

17. The footwear article of claim 16, wherein the first layer is between the second layer and the polymeric film and the first amount is higher than the second amount.

18. A footwear article comprising:
an upper that is coupled to a sole and that comprises a composite textile; and
the composite textile comprising:
a first layer comprising a nonwoven staple-fiber web, which comprises first fibers;
a second layer that is coupled to the first layer and that comprises a mesh material panel having a first side oriented towards the first layer and a second side oriented away from the first layer; wherein the mesh material panel comprises a network of interconnected material segments and a plurality of through-openings; and
a third layer comprising a polymeric film, wherein the second layer is positioned between the third layer and the first layer; wherein the polymeric film comprises a first portion that overlays a material segment of the network of interconnected material segments and a second portion that overlays a through-opening of the plurality of through-openings; wherein the first portion penetrates a first depth into the material segment and the second portion penetrates a second depth through the through-opening and into the nonwoven staple-fiber web; and wherein the second depth is larger than the first depth.

19. The footwear article of claim 18, wherein the first fibers comprise a solid dispersion comprising at least one synthetic polymer and a silicone polymer.

20. The footwear article of claim 18, wherein the material segment comprises a plurality of yarns that are interlooped by knit stitches.

21. The footwear article of claim 20, wherein at least some of the first fibers comprise fiber segments that extend from the first layer and through one or more loops of the knit stitches.

22. The footwear article of claim 21, wherein the first portion of the polymeric film is coupled to the fiber segments extending through the one or more loops and to the plurality of yarns.

23. A footwear article comprising:
an upper that is coupled to a sole and that comprises a composite textile; and
the composite textile comprising:
a first layer comprising a nonwoven layer comprising first fibers;
a second layer that is coupled to the first layer and that comprises a mesh material panel having a first side oriented towards the first layer and a second side oriented away from the first layer; wherein the mesh material panel comprises a network of interconnected material segments and a plurality of through-openings, and wherein the second layer is coupled to the first layer by an adhesive layer positioned between the first layer and the second layer; and
a third layer comprising a polymeric film, wherein the second layer is positioned between the third layer and the first layer.

24. The footwear article of claim 23, wherein the adhesive layer comprises a first thermoplastic hot-melt adhesive layer.

25. The footwear article of claim 24, wherein the polymeric film is coupled to the second side of the second layer by a second thermoplastic hot-melt adhesive layer.

26. The footwear article of claim 25, wherein in a through-opening of the plurality of through-openings, a portion of the first thermoplastic hot-melt adhesive layer is intermixed with a portion of the second thermoplastic hot-melt adhesive layer.

27. The footwear article of claim 23, wherein the mesh material panel comprises a plurality of dyes or pigments comprising a plurality of colors.

28. The footwear article of claim 27, wherein the mesh material panel comprises a warp-nit mesh textile comprising a basis weight greater than 200 gsm, and wherein the nonwoven layer comprises a staple-fiber web comprising a basis weight greater than 300 gsm.
